(19) United States
(12) Patent Application Publication
(10) Pub. No.: US 2012/0295193 A1
(43) Pub. Date: Nov. 22, 2012

(54) TONER AND DEVELOPER

(76) Inventors: Shinya HANATANI, Shizuoka (JP); Naohiro WATANABE, Shizuoka (JP); Tsuyoshi SUGIMOTO, Shizuoka (JP); Tomoyuki SATOH, Kanagawa (JP); Mamoru HOZUMI, Miyagi (JP)

(21) Appl. No.: 13/447,550

(22) Filed: Apr. 16, 2012

(30) Foreign Application Priority Data
May 18, 2011 (JP) 2011-111168

(51) Int. Cl. G03G 9/16

(52) U.S. Cl. 430/109.4; 430/109.1

(57) ABSTRACT

To provide a toner, which contains a binder resin containing a crystalline resin and a non-crystalline resin, a colorant, and a releasing agent, wherein the toner has ½ flow onset temperature T½ of 120° C. to 135° C., and wherein a peak intensity ratio of an intensity of a peak derived from the crystalline resin and the releasing agent to an intensity of a peak derived from the binder resin as measured in FTIR-ATR is 0.10 to 0.20.

### BACKGROUND OF THE INVENTION

1. Field of the Invention

The present invention relates a toner and a developer containing the toner, for use in image forming apparatuses such as photocopiers, facsimiles, and printers.

2. Description of the Related Art

An electrophotographic or electrostatic recording image forming apparatus conventionally perform image forming by visualizing an electric latent image or magnetic latent image with a toner. In electrophotography, for example, a latent electrostatic image is formed on a photoconductor, followed by developing the latent electrostatic image with a toner to form a toner image. The toner image is then transferred onto a recording medium, such as paper, followed by heated and melted to fix the toner image on the recording medium.

Recently, demands in the market include to down size particles diameters of toners for improving image qualities of output images, and to improve low temperature fixing abilities of toners for energy saving. It is difficult to downsize the particle diameters of toners obtained by conventional kneading and pulverization method, and shapes of particles of such toner are irregular, and the particle size distribution thereof is broad. Such toner, moreover, has problems that the fixing temperature needs to be set at high temperature, and difficulty is involved in energy saving. Further, a large amount of a releasing agent (wax) is present on surfaces of toner particles, since according to the kneading and pulverization method, the kneaded product is cracked into pieces at an interface of the releasing agent during pulverizing. Therefore, the releasing effect is exhibited at the time of fixing, but on the other hand, the toner tends to deposit on a carrier, photoconductor, and blade. In view of the image forming process as a whole, the properties of the toner are not satisfactory.

Meanwhile, there has been proposed a toner production method employing a polymerization method in order to solve the problems in the pulverization method. The toner produced by the polymerization method can be easily downsized to have smaller particle diameters, and has a shaper particle size distribution compared to that of the toner produced by the pulverization method. Further, the toner produced by the polymerization method can encapsulate the wax therein.

It is desired to improve low temperature fixing ability of a toner for the purpose of energy saving, in accordance with such polymerization method.

Along the low temperature fixing ability, it is also desired to adjust the toner not to impair its heat resistant storage stability and hot offset resistance.

To solve the aforementioned problems, various attempts have been made by introducing, as a binder resin of a toner, crystalline polyester into a conventionally used non-crystalline resin (see, for example, Japanese Patent Application Laid-Open (JP-A) Nos. 2005-015589, 2005-107387, 2006-065025, 2006-293338, and 2007-033773). The crystalline polyester resin in the toner has thermofusion properties that drastic reduction in its viscosity is exhibited at the temperature around the fixing starting temperature because of its crystallinity. Namely, the heat resistant storage stability of the toner is excellent due to the crystallinity of the crystalline polyester resin just until the temperature reaching the fusion starting temperature, and the toner causes drastic reduction in its viscosity (sharp melt) at the fusion starting temperature to be fixed. As a result, a toner having both excellent heat resistant storage stability and low temperature fixing ability can be designed. Moreover, the toner, which is also excellent in hot offset resistance, can be designed.

As for a toner production method for introducing crystalline polyester to a non-crystalline resin, the following method is disclosed. The method includes: dissolving a compound capable of undergoing a chain elongation or crosslink reaction with a binder resin precursor in an oil phase obtained by dissolving or dispersing, in an organic solvent, at least a binder resin containing a binder resin precursor formed of a crystalline polyester resin and a modified polyester resin, a colorant, and a releasing agent; dispersing the oil phase in an aqueous medium containing a particulate dispersant to obtain an emulsified dispersion liquid; allowing the binder resin precursor to undergo a crosslink reaction and/or an elongation reaction in the emulsified dispersion liquid; and removing the organic solvent.

Introducing the non-crystalline resin into crystalline polyester resin, as in the aforementioned production method, may not be sufficient to achieve low temperature fixing ability of a toner. Even if the low temperature fixing ability is achieved, desirable heat resistant storage stability, or hot offset resistance may not be attained. In order to attain low temperature fixing ability, it is important that the crystalline polyester resin is compatible with a non-crystalline resin to lower the glass transition temperature (Tg) of the toner, and to lower a temperature at which a melt viscosity start decreasing. To secure heat resistant storage stability and hot offset resistance, however, it is important that the crystalline polyester resin and the non-crystalline resin are dispersed without being compatible to each other. To achieve all of the low temperature fixing ability, heat resistant storage stability, and hot offset resistance, it is important to achieve both the compatible state and incompatible state of the non-crystalline resin and crystalline polyester resin, which are in the relationship of trade-off. To this end, there are proposals, including a toner production method (JP-A No. 2005-107387) or a toner (JP-A Nos. 2006-293338 and 2007-033773) specifying a value of an endothermic peak in heating by DSC using a combination of a crystalline polyester resin and a non-crystalline polyester resin.

There are the aforementioned toners to which the crystalline polyester resin is introduced, and which can prevent occurrences of hot offset while attaining low temperature fixing ability of the toner. Although hot offset may not be caused, however, use of such toners causes a problem that printed sheets are wrapped around a fixing roller, and excellent separation ability of the toner cannot be attained. In addition, the toner has been developed to attain heat resistant storage stability, but the effect thereof is not sufficient. The further improvement of the heat resistant storage stability is therefore desired.

### SUMMARY OF THE INVENTION

The present invention aims to provide a toner having excellent low temperature fixing ability and heat resistant storage stability, as well as excellent separating properties, and to provide a developer containing the toner.

The means for solving the aforementioned problem is as follow.

The toner of the present invention containing:

a binder resin containing a crystalline resin and a non-crystalline resin;

a colorant; and

a releasing agent,

wherein the toner has ½ flow onset temperature T½ of 120° C. to 135° C., and

wherein a peak intensity ratio of an intensity of a peak derived from the crystalline resin and the releasing agent to an intensity of a peak derived from the binder resin as measured in FTIR-ATR is 0.10 to 0.20.

The present invention provides a toner having excellent low temperature fixing ability and heat resistant storage stability, as well as separation ability, by specifying, in addition to the glass transition temperature Tg1st of a first heating measured by a differential scanning calorimeter (DSC), the glass transition temperature Tg2nd of the second heating by DSC, ½ flow onset temperature T½ of the toner, and a peak intensity ratio of an intensity of a peak derived from the crystalline resin and the releasing agent to an intensity of a peak derived from the binder resin as measured by FTIR-ATR.

The glass transition temperature Tg1st of the first heating is derived from the glass transition temperature of the crystalline polyester that is used as a resin having the lowest glass transition temperature among resins for forming a toner. In the case where the crystalline polyester and the non-crystalline polyester become partially or entirely compatible to each other during the production, the Tg1st is significantly low. When the Tg1st is lower than 45° C., heat resistant storage stability of the resulting toner is not sufficient. When the Tg1st is higher than 65° C., the temperature at which the toner starts melting is high and thus low temperature fixing ability cannot be attained. Therefore, Tg1st is adjusted to fall into the range of 45° C. to 65° C.

The glass transition temperature determined from the second heating, namely, the glass transition temperature Tg2nd after the thermofusion of the toner, is not derived from materials for forming the toner, but is a characteristic temperature newly generated as a result of compatibility of resins during the aforementioned production process. When the Tg2nd is lower than 25° C., the compatibility of the resins is excessive during the fixing, which may deteriorate the separation ability of the toner at the time of the fixing. When the Tg2nd is higher than 35° C., the compatibility of the resins is insufficient during the fixing, which may deteriorate low temperature fixing ability of the toner. Accordingly, Tg2nd of the toner is controlled to fall into the range of 25° C. to 35° C.

The ½ flow onset temperature T½ of the toner also indicates decrease in the viscosity of the resin, and is determined, for example, from a flow curve obtained by melting and flowing a sample by means of an elevated flow tester, and is a temperature at which the stroke variation from the meltflow onset temperature to the meltflow endset temperature becomes ½. When the ½ flow onset temperature T½ is lower than 120° C., the separation ability of the toner is deteriorated at the time of the fixing. When the ½ flow onset temperature T½ is higher than 135° C., the softening onset temperature of the toner is high, so that the low temperature fixing ability of the toner cannot be attained. Therefore, T½ of the toner is controlled to fall in the range of 120° C. to 135° C.

The index related to the uneven distribution of the crystalline polyester and releasing agent in the area adjacent to the surfaces of the toner particles can be attained from the peak intensity ratio of the intensity of the peak derived from the crystalline polyester resin and releasing agent to the intensity of the peak derived from the binder resin as measured in FTIR-ATR. When the peak intensity ratio is low, it indicates that an amount of the crystalline polyester and releasing agent present around a surface of a toner particle is low. If the peak intensity ratio is less than 0.10, the separation ability of the toner is insufficient. When the peak intensity ratio is high, it indicates that an amount of the crystalline polyester and releasing agent present in the area around a surface of a toner particle is large. If the peak intensity ratio is greater than 0.20, heat resistant storage stability of the resulting toner is insufficient. When a large amount of the releasing agent is present in the area adjacent to a surface of a toner particle, releasing ability of the toner improves, but on the other hand, heat resistant storage stability deteriorates as the releasing agent tends to deposit on surrounding members. When a large amount of the crystalline polyester is present in an area adjacent to a surface of a toner particle, heat resistant storage stability deteriorates. The reason for such deterioration is considered as follows. The crystalline polyester generally has glass transition temperature of 0° C. or lower, and crystallinity degree of 100% or lower, and therefore the dispersed crystalline polyester has a non-crystalline component having glass transition temperature of 0° C. or lower. In the case where the crystalline polyester having such component is present in an area adjacent to a surface of a toner particle, heat resistant storage stability of the toner becomes insufficient. In order to improve heat resistant storage stability with maintaining separation ability, the aforementioned peak intensity ratio derived from the crystalline resin and releasing agent measured by FTIR-ATR is adjusted to fall into the range of 0.10 to 0.20.

As presented in the Examples below, a toner having excellent low temperature fixing ability, heat resistant storage stability, and separation ability can be attained by satisfying the aforementioned four conditions.

The present invention can provide a toner having excellent low temperature fixing ability, heat resistant storage stability, and separation ability, and provide a developer containing the toner.

### BRIEF DESCRIPTION OF THE DRAWING

FIG. 1 is a schematic drawing illustrating an example of a measuring device used for measuring releasing properties in Examples.

### DETAILED DESCRIPTION OF THE INVENTION

### (Toner)

The toner of the present invention contains a binder resin including a crystalline resin and a non-crystalline resin, a colorant, and a releasing agent, and may further contain other components, if necessary.

The toner is obtained by dispersing an oil phase in an aqueous medium containing a particulate disperser to obtain an emulsified dispersion liquid, where the oil phase is obtained by dissolving at least the colorant, the releasing agent (wax), the binder resin including a crystalline polyester resin and the non-crystalline resin, and other binder resins in the organic solvent; and removing the organic solvent from the emulsified dispersion liquid.

In the present invention the glass transition temperature Tg1st of the toner determined from the first heating by DSC is preferably 45° C. to 65° C., the glass transition temperature Tg2nd of the toner determined from the second heating by DSC is preferably 25° C. to 35° C., the ½ flow onset temperature T½ of the toner is 120° C. to 135° C., and a peak intensity ratio of an intensity of a peak derived from the crystalline resin and the releasing agent to an intensity of a peak derived from the binder resin as measured in FTIR-ATR is 0.10 to 0.20.

The binder resin moreover contains a binder resin precursor formed of a modified polyester resin, and the binder resin is obtained by dissolving a compound capable of elongating or crosslinking with the binder resin precursor to form an oil phase, and allowing the binder resin precursor to undergo a crosslink reaction and/or elongation reaction in an emulsification dispersion liquid.

Materials used for obtaining the aforementioned toner, and production processes using the materials will be explained next.

### <Organic Solvent>

As for the organic solvent, an organic solvent, which can form a homogeneous solution by completely dissolving the crystalline polyester resin therein at high temperature, and causes a phase separation with the crystalline polyester resin as cooled to low temperature to form an opaque heterogeneous solution, can be used. Examples of the organic solvent include toluene, ethyl acetate, butyl acetate, methyl ethyl ketone, and methyl isobutyl ketone. These may be used independently, or in combination.

### <Crystalline Resin>

The crystalline resin is appropriately selected without any restriction, provided that it has crystallinity, but it is preferably a crystalline polyester resin. The crystalline polyester resin has the thermofusion properties that the viscosity decreases in the vicinity of a temperature at which the fixing is initiated. That is, the crystalline polyester resin has good heat resistant storage stability due to its crystallinity just below the temperature at which the crystalline polyester resin starts being fused, and rapidly decreases its viscosity (sharp melt property) at the temperature at which the crystalline polyester resin starts being fused, to thereby be fixed. Accordingly, use of the crystalline polyester resin in a toner enables to design a toner having both excellent heat resistant storage stability and low temperature fixing ability. By using the crystalline polyester resin, moreover, a toner exhibiting an excellent result in a releasing width (difference between the minimum fixing temperature and hot offset occurring temperature) can be designed.

As a result of diligent studies conducted by the present inventors to satisfy both the low temperature fixing ability and heat resistant storage stability of the toner, it has been found that the crystalline polyester resin preferably has an endothermic peak temperature of 60° C. to 80° C. When the endothermic peak temperature is lower than 60° C., the resulting toner may have insufficient heat resistant storage stability. When the endothermic peak temperature is higher than 80° C., the resulting toner may have insufficient low temperature fixing ability.

The endothermic peak temperature of the crystalline polyester resin can be adjusted by adjusting monomers for forming the crystalline polyester resin, and the weight average molecular weight thereof. In order to reduce the difference between the endothermic shoulder temperature and the endothermic peak temperature, the monomer composition is adjusted to increase the crystallinity of the crystalline polyester resin, specifically adjusted by increasing the probability of overlapping the identical structure in a molecular chain by forming the acid and alcohol monomer compositions with similar compounds. Alternatively, it can be adjusted by reducing the difference between the number average molecular weight and weight average molecular weight of the crystalline polyester resin.

The endothermic value of the crystalline polyester resin can be measured, for example, by means of a differential scanning calorimeter (DSC) system (DSC-60, manufactured by Shimadzu Corporation) in the following method. First, about 5.0 g of a polyester resin is placed in an aluminum sample container, the sample container is placed on a holder unit, followed by setting in an electric furnace. Next, the sample is heated to from 0° C. to 150° C. at the heating rate of 10° C./min under the nitrogen atmosphere, followed by cooling from 150° C. to 0° C. at the cooling rate of 10° C./min. Thereafter, the sample is again heated to 150° C. at the heating rate of 10° C./min, followed by measuring a DSC curve by means of the differential scanning calorimeter (DSC-60, manufactured by Shimadzu Corporation). From the obtained DSC curve, the DSC curve for the first heating is selected using an analysis program stored in the DSC-60 system, and an endothermic shoulder 1 and endothermic shoulder 2 of the first heating of the sample are determined by using “endothermic shoulder temperature” in the analysis program. Next, the DSC curve of the second heating is selected, and an endothermic shoulder 1 and endothermic shoulder 2 of the second heating of the sample are determined by using “endothermic shoulder temperature” in the analysis program. The shoulder temperatures are determined as endothermic shoulder 1 and endothermic shoulder 2 in the order from the lower temperature. Moreover, the DSC curve of the first heating is selected from the obtained DSC curve using the analysis program stored in DSC-60 system, and an endothermic peak of the first heating of the sample is determined by using “endothermic peak temperature” in the analysis program. The DSC curve of the second heating is selected, and an endothermic peak of the second heating of the sample is determined using “endothermic temperature” in the analysis program.

The crystalline polyester resin is synthesized from an alcohol component and an acid component.

Examples of the alcohol component include a C2-C12 saturated aliphatic diol compound. Examples of the C2-C12 saturated aliphatic diol compound include 1,4-butanediol, 1,5-pentanediol, 1,6-hexanediol, 1,8-octanediol, 1,10-decanediol, 1,12-dodecanediol, and derivatives of the preceding diol compounds.

Examples of the acid component include a C2-C12 dicarboxylic acid containing a carbon double bond (C═C), and a C2-C12 saturated dicarboxylic acid.

Examples of the C2-C12 dicarboxylic acid containing a carbon double bond (C═C) or the C2-C12 saturated dicarboxylic acid include adipic acid, fumaric acid, 1,4-butanedioic acid, 1,6-hexanedioic acid, 1,8-octanedioic acid, 1,10-decanedioic acid, 1,12-dodecanedioic acid, and derivatives of the preceding acids.

Among them, the crystalline polyester is preferably consisted of a C4-C12 saturated diol component that is at least selected from the group consisting of 1,4-butanediol, 1,5-pentanediol, 1,6-hexanediol, 1,8-octanediol, 1,10-decanediol, and 1,12-dodecanediol, and a C4-C12 saturated dicarboxylic acid component that is at least one selected from the group consisting of 1,4-butanedioic acid, 1,6-hexanedioic acid, 1,8-octanedioic acid, 1,10-decanedioic acid, and 1,12-dodecanedioic acid, because high crystallinity of the resulting crystalline polyester can be attained, and the resulting crystalline polyester exhibits drastic viscosity change at the temperature around the melting point.

As for a method for controlling the crystallinity and softening point of the crystalline polyester resin, there is a method for designing and using a non-linear polyester obtained by polycondensation that is performed by adding trihydric or higher polyhydric alcohol (e.g. glycerin) to the alcohol component, or adding trivalent or higher polycarboxylic acid (e.g. trimetllitic anhydride) to or acid component during the synthesis of the polyester.

The molecular structure of the crystalline polyester resin can be confirmed, for example, by NMR measurement of the crystalline polyester resin in a solution or as a solid, as well as by measurement of the crystalline polyester resin using X-ray diffraction, GC/MS, LC/MS, and IR. For example, simply in the infrared absorption spectrum, the crystalline polyester resin having an absorption at wavelengths of 965 cm⁻¹±10 cm⁻¹ and 990 cm⁻¹±10 cm⁻¹, which is based on an out-of-plane bending vibration (δCH) of an olefin, is described here as one of the examples thereof.

Regarding the molecular weight of the crystalline polyester, the studies have been conducted by the present inventors based on insights that the low molecular weight crystalline polyester having a sharp molecular weight distribution has excellent, and the crystalline polyester has poor heat resistance storage stability when it contains a high low molecular weight-molecule content. As a result, in the case where the weight average molecular weight is 5,000 to 20,000, the proportion of molecules having the number average molecular weight Mn of 500 or smaller is 0% to 2.5%, and the proportion of molecules having the number average molecular weight Mn of 1,000 or smaller is 0% 5.0% in the molecular weight distribution as measured by GPC of a soluble matter of o-dichlorobenzene, both the low temperature fixing ability and heat resistant storage stability of the toner can be attained. More preferably, the proportion of the molecules having the number average molecular weight Mn of 500 or smaller is 0% to 2.0%, and the proportion of the molecules having the number average molecular weight Mn of 1,000 or smaller is 0% to 4.0%.

The molecular weight distribution can be measured, for example, by means of a gel permeation chromatography (GPC) measuring device (GPC-8220GPC, manufactured by TOSOH CORPORATION), under the following conditions.

Column: TSKgel SuperHZM-H, 15 cm, three connected columns (TOSOH CORPORATION)

Temperature: 40° C.

Solvent: tetrahydrofuran (THF)

Flow rate: 0.35 mL/min

Sample: 0.4 mL of a 0.15% sample to be supplied

As for the pretreatment of the sample, the sample is dissolved in tetrahydrofuran (THF) (containing a stabilizer, manufactured by Wako Chemical Industries, Ltd.) to give a concentration of 0.15% by mass, the resulting solution is then filtered through a filter having a pore size of 0.2 μm, and the filtrate from the filtration is used as a sample. The measurement is performed by supplying 100 μL of the tetrahydrofuran (THF) sample solution. For the measurement of the molecular weight distribution of the sample, a molecular weight distribution of the sample is calculated from the relationship between the logarithmic value of the calibration curve prepared from a several monodispersible polystyrene standard samples and the number of counts. As the standard polystyrene samples for preparing the calibration curve, Showdex STANDARD Std. Nos. S-7300, S-210, S-390, S-875, S-1980, S-10.9, S-629, S-3.0, and S-0.580 of SHOWA DENKO K.K., and toluene are used. As the detector, a refractive index (RI) detector is used.

The acid value and hydroxyl value of the crystalline polyester resin satisfy the following relationships, as determining the acid value as A, and hydroxyl value as B:

10 mgKOH/g<A<40 mgKOH/g

0 mgKOH/g<B<20 mgKOH/g

20 mgKOH/g<A+B<40 mgKOH/g

When the acid value A is 10 mgKOH/g or lower, the resulting toner has poor compatibility to paper that is a recording member, which may cause deterioration in the heat resistant storage stability. When the acid value A is 40 mgKOH/g or higher, or the hydroxyl value B is 20 mgKOH/g or lower, there is a possibility that the toner reduces its charging ability in the high temperature and high humidity environment. When the sum of the acid value A and the hydroxyl value B (A+B) is 20 mgKOH/g or lower, the compatibility with the non-crystalline polyester resin reduces, and therefore low temperature fixing ability may not be attained in some cases. When the sum of the acid value A and the hydroxyl value B (A+B) is 40 mgKOH/g or higher, the degree of the compatibility between the crystalline polyester resin and the non-crystalline polyester resin becomes excessive, which may cause deterioration of heat resistant storage stability in some cases.

The acid value is an indicator for the number of carboxylic acid groups in a resin, and the hydroxyl value is an indicator for the number of hydroxyl groups in a resin. These values are measured by a method according to JIS K0070-1992.

A method for dissolving and re-crystallizing the crystalline polyester resin in the organic solvent is as follow.

The crystalline polyester resin (10 g) and the organic solvent (90 g) are mixed and stirred for 1 hour at 70° C. The solution obtained after the stirring is cooled for 12 hours at 20° C. to re-crystallize the crystalline polyester resin. The organic solvent dispersion liquid of the re-crystallized crystalline polyester resin is subjected to aspiration filtration by means of an aspirator using a KIRIYAMA funnel (product of Kiriyama glass Co.) in which a filter paper No. 4 for KIRIYAMA funnel (product of Kiriyama glass Co.) has been set, to thereby separate the crystalline polyester resin from the organic solvent. The crystalline polyester resin obtained by the separation is dried for 48 hours at 35° C., to thereby obtain a re-crystallized product of the crystalline polyester resin.

The solubility of the crystalline polyester to the organic acid is preferably 10 parts by mass or more, more preferably parts by mass to parts by mass at 70° C. When the solubility is less than 10 parts by mass, it is difficult to disperse the crystalline polyester resin to the size of submicron in an organic solvent, because the affinity between the organic solvent and the crystalline polyester resin is poor, which may result in the unevenly provided crystalline polyester resin within the toner particles, causing insufficient charging ability, and poor image quality after long term use.

The solubility of the crystalline polyester to an organic solvent at 20° C. is preferably less than 3.0 parts by mass, more preferably parts by mass to parts by mass. When the solubility is 3.0 parts by mass or more, the crystalline polyester resin dissolved in the organic solvent tends to be compatible with the non-crystalline polyester resin even before heating, which may lead to poor heat resistant storage stability, contamination of a developing unit, or deterioration of images.

The solubility of the crystalline polyester resin to the organic solvent can be measured by the following method.

First, 20 g of the crystalline polyester resin and 80 g of the organic solvent are stirred for 1 hour at a predetermined temperature. A filter paper No. 4 for KIRIYAMA funnel (product of Kiriyama glass Co.) is set to a KIRIYAMA funnel (product of Kiriyama glass Co.). Using the KIRIYAMA funnel, the resulting solution is subjected to aspiration filtration with an aspirator at a predetermined temperature, to thereby separate the crystalline polyester resin from the organic solvent. The organic solvent obtained by the separation is heated for 1 hour at the temperature that is higher than the boiling point of the organic solvent by 50° C., to evaporate the organic solvent. The amount of the crystalline polyester resin dissolved in the organic solvent is calculated from the change in weight before and after the heating.

### <Binder Resin Precursor>

The binder resin preferably contains a binder resin precursor.

The binder resin precursor is preferably a binder resin precursor formed of a modified polyester resin, and examples thereof include polyester prepolymer modified with isocyanate or epoxy. The polyester prepolymer undergoes an elongation reaction with a compound containing an active hydrogen group (e.g., amines) to give an effect of improving a release width (a difference between the minimum fixing temperature and hot offset occurring temperature). Regarding the synthesis method of the polyester prepolymer, the polyester prepolymer can be easily synthesized by allowing the conventional isocyanating agent or epoxydizing agent to react with a polyester resin that is a base.

Examples of the isocyanating agent include: aliphatic polyisocyanate (e.g., tetramethylene diisocyanate, hexamethylene diisocyanate, and 2,6-diisocyanate methyl caproate); alicyclic polyisocyanate (e.g., isophorone diisocyanate, and cyclohexylmethane diisocyanate); aromatic diisocyanate (e.g., tolylene diisocyanate, and diphenylmethane diisocyanate); aromatic aliphatic diisocyanate (e.g., α,α,α′,α′-tetramethyl xylylene diisocyanate); isocyanurates; the preceding polyisocyanates blocked with phenol derivatives, oxime, or caprolactam; and a mixture of any of the preceding polyisocyanates. Examples of the epoxydizing agent include epichlorohydrin.

The ratio of the isocyanating agent is determined as an equivalent ratio [NCO]/[OH] of the isocyanate groups [NCO] to hydroxyl groups [OH] of the polyester to be a base. The ratio [NCO]/[OH] is typically 5/1 to 1/1, preferably 4/1 to 1.2/1, and even more preferably 2.5/1 to 1.5/1. When the ratio [NCO]/[OH] is higher than 5, the resulting toner may have insufficient low temperature fixing ability. When the molar ratio of [NCO] is less than 1, the polyester prepolymer has a low urea content, which may lead to insufficient hot offset resistance of the resulting toner.

An amount of the isocyanating agent in the polyester prepolymer is typically 0.5% by mass to 40% by mass, preferably 1% by mass to 30% by mass, and more preferably 2% by mass to 20% by mass. When the amount thereof is smaller than 0.5% by mass, the heat resistant storage stability and low temperature fixing ability of the toner may not be achieved at the same time, as well as not attaining sufficient hot offset resistance. When the amount thereof is larger than 40% by mass, the resulting toner may have insufficient low temperature fixing ability.

The number of the isocyanate groups contained in the polyester prepolymer per molecule is typically 1 or more, preferably 1.5 to 3 on average, and more preferably 1.8 to 2.5 on average. When the number of the isocyanate groups per molecule is less than 1, the urea-modified polyester resin after the elongation reaction has a small molecular weight, which may lead to insufficient hot offset resistance.

The binder resin precursor preferably has the weight average molecular weight of 1×10⁴ to 3×10⁵.

<<Compound Elongated or Crosslinked with Binder Resin Precursor >>

Examples of the compound elongated or crosslinked with the binder resin precursor includes a compound containing an active hydrogen group, and typical examples thereof include amines.

Examples of the amines include a diamine compound, a trivalent or higher polyamine compound, an amino alcohol compound, an amino mercaptan compound, an amino acid compound, and a blocked compound where an amino group of any of the preceding amines is blocked.

Examples of the diamine compound include: aromatic diamine (e.g., phenylene diamine, diethyltoluene diamine, and 4,4′-diaminodiphenyl methane), alicyclic diamine (4,4′-diamino-3,3′-dimethyldicyclohexyl methane, diamine cyclohexane, and isophorone diamine), and aliphatic diamine (e.g., ethylene diamine, tetramethylene diamine, and hexamethylene diamine).

Examples of the trivalent or higher polyamine compound include diethylene triamine, and triethylene tetramine.

Examples of the amino alcohol compound include ethanol amine, and hydroxyethyl aniline.

Examples of the amino mercaptan compound include aminoethylmercaptan, and aminopropylmercaptan.

Examples of the amino acid compound include amino propionic acid, and amino caproic acid.

Examples of the blocked compound where an amino group of any of the preceding amines is blocked include a ketimine compound and oxazoline compound obtained from the amines and ketones (e.g., acetone, methyl ethyl ketone, and methyl isobutyl ketone). Among the aforementioned amines, the diamine compound and, a mixture of the diamine compound and a small amount of the polyamine compound are preferable.

### <Colorant>

The colorant is appropriately selected depending on the intended purpose without any restriction. Examples of the colorant include carbon black, a nigrosin dye, iron black, naphthol yellow S, Hansa yellow (10G, 5G and G), cadmium yellow, yellow iron oxide, yellow ocher, yellow lead, titanium yellow, polyazo yellow, oil yellow, Hansa yellow (GR, A, RN and R), pigment yellow L, benzidine yellow (G and GR), permanent yellow (NCG), vulcan fast yellow (5G, R), tartrazinelake, quinoline yellow lake, anthrasan yellow BGL, isoindolinon yellow, colcothar, red lead, lead vermilion, cadmium red, cadmium mercury red, antimony vermilion, permanent red 4R, parared, fiser red, parachloroorthonitro anilin red, lithol fast scarlet G, brilliant fast scarlet, brilliant carmine BS, permanent red (F2R, F4R, FRL, FRLL and F4RH), fast scarlet VD, vulcan fast rubin B, brilliant scarlet G, lithol rubin GX, permanent red FSR, brilliant carmine 6B, pigment scarlet 3B, Bordeaux 5B, toluidine Maroon, permanent Bordeaux F2K, Helio Bordeaux BL, Bordeaux 10B, BON maroon light, BON maroon medium, eosin lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, Victoria blue lake, metal-free phthalocyanine blue, phthalocyanine blue, fast sky blue, indanthrene blue (RS and BC), indigo, ultramarine, iron blue, anthraquinone blue, fast violet B, methyl violet lake, cobalt purple, manganese violet, dioxane violet, anthraquinone violet, chrome green, zinc green, chromium oxide, viridian, emerald green, pigment green B, naphthol green B, green gold, acid green lake, malachite green lake, phthalocyanine green, anthraquinone green, titanium oxide, zinc flower, lithopone, and a mixture of two or more of the preceding colorants.

An amount of the colorant is preferably 1% by mass to 15% by mass, more preferably 3% by mass to 10% by mass, relative to the toner.

The colorant may be used as a master batch in which the colorant forms a composite with a resin. Examples of the binder resin kneaded in the production of, or together with the master batch include, other than the aforementioned modified and unmodified polyester resins, polymer of styrene or substitution thereof (e.g., polystyrene, poly-p-chlorostyrene, and polyvinyl); styrene copolymer (e.g., styrene-p-chlorostyrene copolymer, styrene-propylene copolymer, styrene-vinyl toluene copolymer, styrene-vinyl naphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-methyl or chloromethacrylate copolymer, styrene-acrylonitrile copolymer, styrene-vinyl methyl ketone copolymer, styrene-butadiene copolymer, styrene-isoprene copolymer, styrene-acrylonitrile-indene copolymer, styrene-maleic acid copolymer, and styrene-maleic acid ester copolymer); and others including polymethyl methacrylate, polybutyl methacrylate, polyvinyl chloride, polyvinyl acetate, polyethylene, polypropylene, polyester, epoxy resin, epoxy polyol resin, polyurethane, polyamide, polyvinyl butyral, polyacrylic acid resin, rosin, modified rosin, a terpene resin, an aliphatic or alicyclic hydrocarbon resin, an aromatic petroleum resin, chlorinated paraffin, and paraffin wax. These may be used independently, or in combination.

The master batch can be prepared by mixing and kneading the colorant with the resin for the master batch. In the mixing and kneading, an organic solvent may be used for improving the interactions between the colorant and the resin. Moreover, the master batch can be prepared by a flashing method in which an aqueous paste containing a colorant is mixed and kneaded with a resin and an organic solvent, and then the colorant is transferred to the resin to remove the water and the organic solvent. This method is preferably used because a wet cake of the colorant is used as it is, and it is not necessary to dry the wet cake of the colorant to prepare a colorant. In the mixing and kneading of the colorant and the resin, a high-shearing disperser (e.g., a three-roll mill) is preferably used.

### <Releasing Agent>

The releasing agent is preferably wax having a melting point of 50° C. to 120° C.

The wax effectively functions as a releasing agent at an interface between the fixing roller and the toner, and therefore hot offset resistance can be improved without applying a releasing agent (e.g. oil) onto the fixing roller.

Note that, a melting point of the wax is determined, for example, by measuring the maximum endothermic peak of the wax by means of TG-DSC System TAS-100 (manufactured by Rigaku Corporation), which is a differential scanning calorimeter.

The below-listed materials can be used as the releasing agent.

Examples of the wax include vegetable wax (e.g., carnauba wax, cotton wax, Japan wax and rice wax), animal wax (e.g., bees wax and lanolin), mineral wax (e.g., ozokelite and ceresine) and petroleum wax (e.g., paraffin wax, microcrystalline wax and petrolatum).

Examples of the wax other than the above natural wax include synthetic hydrocarbon wax (e.g., Fischer-Tropsch wax and polyethylene wax; and synthetic wax (e.g., ester wax, ketone wax and ether wax).

Further, other examples of the releasing agent include fatty acid amides such as 1,2-hydroxystearic acid amide, stearic amide, phthalic anhydride imide and chlorinated hydrocarbons; low-molecular-weight crystalline polymers such as acrylic homopolymers (e.g., poly-n-stearyl methacrylate and poly-n-lauryl methacrylate) and acrylic copolymers (e.g., n-stearyl acrylate-ethyl methacrylate copolymers); and crystalline polymers having a long alkyl group as a side chain.

### <Wax Dispersant>

For the toner, a wax dispersant for dispersing wax contained as the releasing agent may be used. Since the wax has low compatibility with the non-crystalline resin that is the binder resin, the wax is unevenly distributed so that the large amount thereof is located adjacent to surfaces of toner particles, unless the wax dispersant is used. When the wax dispersant is used, the wax increases the affinity to the binder resin so that the wax is dispersed in the inner parts of the toner particles. The wax dispersant has an effect of improving the dispersibility of the crystalline polyester resin, as well as improving the dispersibility of the wax. Specifically, the wax dispersant has a function as a dispersant for improving dispersibilities of the crystalline polyester resin and the releasing agent (wax). By varying the amount of the aforementioned wax dispersant, the amounts of the crystalline polyester and wax located adjacent to the surfaces of the toner particles can be controlled.

The wax dispersant is a graft polymer having a structure where the resin (B) described below is grafted as a side chain to a main chain of the resin (A) described below.

The resin (A) is appropriately selected from conventional releasing agents, as long as the resin (B) can be grafted thereto. For example, the resin (A) is a polyolefin resin, preferably a polyolefin resin produced by thermal decomposition. Examples of the olefins for forming the polyolefin resin include ethylene, propylene, 1-butene, isobutylene, 1-hexene, 1-dodecene, and 1-octadecene.

Examples of the polyolefin resin include a polymer of olefins, an oxide of a polymer of olefins, a modified product of a polymer of olefins, and a copolymer of olefins and other monomers copolymerizable with the olefins.

Examples of the polymer of olefins include polyethylene, polypropylene, and ethylene-propylene copolymer, ethylene-1-butene copolymer, and propylene-1-hexene copolymer. Examples of the oxide of the polymer of olefins include oxides of the aforementioned polymers of olefins. Examples of the modified product of the polymer of olefins include maleic acid derivative (e.g., maleic anhydride, monomethyl maleate, monobutyl maleate, and dimethyl maleate) adduct of the aforementioned polymer of olefins. Examples of the copolymer of olefins and other monomers copolymerizable with olefins include copolymers of olefins and monomers such as unsaturated carboxylic acid (e.g., (meth)acrylic acid, itaconic acid, and maleic anhydride), unsaturated carboxylic acid alkyl ester (e.g., alkyl(C1-C8)(meth)acrylate, and alkyl(C1-C8)maleate).

In the present embodiment, moreover, the monomer does not need to include an olefin structure, as long as the polymer structure has the structure of polyolefin. For example, polymethylene (sasol wax etc.) can be used. Among these polyolefin resins, the polymer of olefins, oxide of polymer of olefin, and modified product of polymer of olefins are preferable; polyethylene, polymethylene, polypropylene, ethylene/propylene polymer, oxidized polyethylene, oxidized polypropylene, and maleinized polypropylene are more preferable; and polyethylene and poly propylene are even more preferable.

Examples of the monomer for forming the resin (B) include alkyl (C1-C5) ester (e.g., methyl(meth)acrylate, ethyl(meth)acrylate, butyl(meth)acrylate, 2-ethylhexyl(meth)acrylate) of unsaturated carboxylic acid, and a vinyl ester monomer (e.g. vinyl acetate). Among them, alkyl(meth)acrylate is preferable, and C1-C5 alkyl(meth)acrylate (B1) is more preferable.

Examples of the aromatic vinyl monomer (B2) used in combination with (B1) as the monomers for forming the resin (B) include styrene monomers, such as styrene, α-methyl styrene, p-methyl styrene, m-methyl styrene, p-methoxystyrene, p-hydroxystyrene, p-acetoxystyrene, vinyl toluene, ethylstyrene, phenyl styrene, and benzyl styrene. Among them, styrene is particularly preferable.

The particle diameter of the wax dispersant is measured, for example, by means of LA-920 (manufactured by Horiba, Ltd.). In the measurement performed by LA-920, an application (Ver 3.32) (of Horiba, Ltd.) for LA-920 is used for analysis.

Specifically, after adjusting an optical axis using a solvent in which the wax dispersant is dispersed, a background is measured. Thereafter, circulation is started, and a wax dispersion liquid is added dropwise thereto. After confirming that the transmittance is stabilized, ultrasonic waves are applied under the following conditions. After the application of the ultrasonic waves, diameters of dispersed particles are measured at the condition where the value of the transmittance falls into the range of 70% to 95%. It is important that the measurement is performed at the condition where the value of the transmittance of LA-920 falls into the range of 70% to 95% to achieve the reproducibility of the measurement of particle diameters by the measuring device. In the case where the value of the transmittance becomes out of the aforementioned range after the application of ultrasonic waves, the measurement needs to be performed again. In order to attain the aforementioned value of the transmittance, the drip of the dispersion liquid needs to be adjusted.

The conditions for the measurement and analysis are set as follows:

Number of data reading: 15

Relative refractive index: 1.20

Circulation: 5

Ultrasonic wave intensity: 7

### <Charge Controlling Agent>

The toner may contain further a charge controlling agent, if necessary. The charge controlling agent is appropriately selected depending on the intended purpose without any restriction, and examples thereof include nigrosine dyes, triphenylmethane dyes, chrome-containing metal complex dyes, molybdic acid chelate pigments, rhodamine dyes, alkoxy amines, quaternary ammonium salts (including fluorine-modified quaternary ammonium salts), alkylamides, phosphorus, phosphorus compounds, tungsten, tungsten compounds, fluorine active agents, metal salts of salicylic acid, and metal salts of salicylic acid derivatives.

As for the charge controlling agent, commercial products can be used. Examples of the commercial products include: nigrosine dye BONTRON 03, quaternary ammonium salt BONTRON P-51, metal-containing azo dye BONTRON S-34, oxynaphthoic acid-based metal complex E-82, salicylic acid-based metal complex E-84 and phenol condensate E-89 (all manufactured by ORIENT CHEMICAL INDUSTRIES CO., LTD); quaternary ammonium salt molybdenum complex TP-302 and TP-415 (all manufactured by Hodogaya Chemical Co., Ltd.); quaternary ammonium salt COPY CHARGE PSY VP 2038, triphenylmethane derivative COPY BLUE PR, quaternary ammonium salt COPY CHARGE NEG VP2036 and COPY CHARGE NX VP434 (all manufactured by Hoechst AG); LRA-901; boron complex LR-147 (manufactured by Japan Carlit Co., Ltd.); copper phthalocyanine; perylene; quinacridone; azo pigments; and polymeric compounds having, as a functional group, a sulfonic acid group, carboxyl group, quaternary ammonium salt, etc.

The amount of the charge controlling agent contained is not determined flatly and is varied depending on the type of the binder resin used, on an optionally used additive, and on the toner production method used (including the dispersion method used). The amount of the charge controlling agent is preferably 0.1 parts by mass to 10 parts by mass, more preferably 0.2 parts by mass to 5 parts by mass, relative to 100 parts by mass of the binder resin. When the amount thereof is larger than 10 parts by mass, the charging ability of the toner becomes excessive, which may reduce the effect of the charge controlling agent, increase electrostatic force to a developing roller, leading to low flowability of the developer, or low image density of the resulting image. These charge controlling agents may be dissolved and dispersed after being melted and kneaded together with the master batch, and/or resin. The charge controlling agents can be, of course, directly added to an organic solvent when dissolution and dispersion is performed. Alternatively, the charge controlling agents may be fixed on surfaces of toner particles after the production of the toner particles.

### <Non-Crystalline Polyester Resin>

The toner of the present invention contains a non-crystalline unmodified polyester resin as the binder resin. It is preferred that the modified polyester resin obtained by a crosslink and/or elongation reaction of the binder resin precursor formed of the modified polyester and the unmodified polyester resin be at least partially compatible to each other. Use of these resins in combination can improve the low temperature fixing ability and hot offset resistance of the resulting toner. Therefore, polyol and polycarboxylic acid used for forming the unmodified polyester resin are preferably the same or similar to those used for forming the modified polyester resin. As for the unmodified polyester resin, the non-crystalline polyester resin used in the crystalline polyester dispersion liquid can be also used, as long as it is unmodified.

The crystalline polyester resin and the non-crystalline polyester resin preferably satisfy the following relationship, when the acid value of the crystalline polyester is determined as A, and the acid value of the non-crystalline polyester resin is determined as C.

−10 mgKOH/g<A−C<10 mgKOH/g

When a difference in the acid value between the crystalline polyester and non-crystalline polyester is 10 or more, the compatibility and affinity between the crystalline polyester and the non-crystalline polyester are poor, which may lead to poor low temperature fixing ability of the resulting toner. Moreover, in such case, the crystalline polyester tends to be exposed on a surface of a toner particle, which tends to cause contamination of a developing unit, and filming.

Note that, the urea-modified polyester resin can be used together with a polyester resin modified with a chemical bond other than urea bond, e.g., a polyester resin modified with a urethane bond, other than unmodified polyester resin.

In the case where the toner composition contains a modified polyester resin such as a urea-modified polyester resin, the modified polyester resin can be produced by a one-shot method.

One example of the production method of the urea-modified polyester resin is explained.

First, polyol and polycarboxylic acid are heated to 150° C. to 280° C. in the presence of a catalyst (e.g., tetrabutoxy titanate, and dibutyl tin oxide), and generated water is removed, optionally under the reduced pressure, to thereby obtain a polyester resin containing a hydroxyl group. Next, the polyester resin containing a hydroxyl group and polyisocyanate are allowed to react at 40° C. to 140° C., to thereby obtain polyester prepolymer containing an isocyanate group. The polyester prepolymer containing an isocyanate group is then allowed to react with amines at 0° C. to 140° C., to thereby obtain a urea-modified polyester resin.

The number average molecular weight of the urea-modified polyester resin is typically 1,000 to 10,000, and preferably 1,500 to 6,000.

A solvent is optionally used for the reaction of the polyester resin containing a hydroxyl group with the polyisocyanate, and the reaction of the polyester prepolymer containing an isocyanate group with the amines.

The solvent is appropriately selected depending on the intended purpose without any restriction, and examples thereof include solvents that are inert to an isocyanate group, such as an aromatic solvent (e.g., toluene, and xylene), ketones (e.g., acetone, methyl ethyl ketone, and methyl isobutyl ketone), esters (e.g., ethyl acetate), amides (e.g., dimethyl formamide, and dimethyl acetoamide), and ethers (e.g., tetrahydrofuran).

In the case where an unmodified polyester resin is used in combination with the urea-modified polyester resin, the one produced in the same manner as the production of the polyester resin containing a hydroxyl group may be added into and mixed with the solution after the reaction for obtaining the urea-modified polyester resin.

As for the binder resin contained in the oil phase to produce the toner, the aforementioned crystalline polyester resin, non-crystalline polyester resin, binder resin precursor, and unmodified resin may be used in combination, and the binder resin may further contain a resin other than the aforementioned resins. The binder resin preferably contains a polyester resin, more preferably containing the polyester resin in an amount of 50% by mass or larger. When the amount of the polyester resin is smaller than 50% by mass, the resulting toner may have insufficient low temperature fixing ability. It is particularly preferred that all of the resins contained as the binder resin are polyester resins.

Examples of the binder resin other than the polyester resin include: styrene polymer or polymer of styrene derivative substitute, such as polystyrene, poly (p-chlorostyrene), and polyvinyl toluene; styrene copolymer such as styrene-p-chlorostyrene copolymer, styrene-propylene copolymer, styrene-vinyl toluene copolymer, styrene-vinyl naphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-methyl-α-chloromethacrylate copolymer, styrene-acrylonitrile copolymer, styrene-vinyl methyl ketone copolymer, styrene-butadiene copolymer, styrene-isoprene copolymer, styrene-acrylonitrile-indene copolymer, styrene-maleic acid copolymer, and styrene-maleate copolymer; and others such as polymethyl methacrylate, polybutyl methacrylate, polyvinyl chloride, polyvinyl acetate, polyethylene, polypropylene, an epoxy resin, an epoxy polyol resin, a polyurethane resin, a polyamide resin, polyvinyl butyral, polyacrylic acid resin, rosin, modified rosin, a terpene resin, an aliphatic or alicyclic hydrocarbon resin, an aromatic peteronium resin, chlorinated paraffin, and paraffin wax.

### <Toner Production Method Using Aqueous Solvent>

An aqueous medium used for the production of the toner of the present invention may be water alone, or a combination of water and a solvent miscible with water. Examples of the solvent miscible with the water include alcohol (e.g., methanol, isopropanol, and ethylene glycol), dimethyl formamide, tetrahydrofuran, cellosolves (e.g., methyl cellosolve), and lower ketones (e.g., acetone, and methyl ethyl ketone).

Materials for forming toner particles (may also referred to as “toner material” as a generic term), such as the binder resin precursor, the colorant, the releasing agent, the crystalline polyester, the charge controlling agent, and the unmodified polyester resin, may be added and mixed when dispersed elements are formed in the aqueous medium, but it is more preferred that these materials be mixed in advance, and a mixture of the materials be added to the aqueous medium and dispersed therein. In the production of the toner of this embodiment, it is not necessary to add other materials for forming the toner, such as the colorant, the releasing agent, and the charge controlling agent, when particles are formed in the aqueous medium. These materials may be added after forming particles. For example, a colorant can be added by a conventional dyeing method after forming particles without containing the colorant.

The method of dispersing is appropriately selected depending on the intended purpose without any restriction, and examples thereof include dispersing by means of a low-speed shearing disperser, a high-speed shearing disperser, a friction disperser, a high-pressure jetting disperser and an ultrasonic wave disperser. Among them, use of the high-speed shearing disperser is preferable as the resulting dispersed elements can achieve the particle diameters of 2 μm to 20 μm.

In the case where the high-speed shearing disperser is used for dispersing, the rotating speed is appropriately selected depending on the intended purpose without any restriction, but it is preferably 1,000 rpm to 30,000 rpm, more preferably 5,000 rpm to 20,000 rpm. The duration for dispersing is not particularly restricted, but in the case of the batch system, it is typically 0.1 minutes to 60 minutes. The temperature for dispersing is typically preferably 0° C. to 80° C. (under pressure), more preferably 10° C. to 40° C.

The amount of the aqueous medium used is typically 100 parts by mass to 1,000 parts by mass, relative to 100 parts by mass of the toner material. When the amount of the aqueous medium is smaller than 100 parts by mass, the toner material is not desirably dispersed, so that toner particles of the intended particle diameters may not be attained. When the amount thereof is larger than 1,000 parts by mass, it is not economical. Moreover, a dispersant is optionally used. Use of the dispersant is preferable because the resulting particles have a sharp particle size distribution, and the dispersion state is stabilized.

As for the method of proceeding to a reaction of the polyester prepolymer with a compound containing an active hydrogen group, the compound containing an active hydrogen group is added to the aqueous medium before the toner material is dispersed in an aqueous medium, followed by allowing the polyester prepolymer to react with the compound containing an active hydrogen group. Alternatively, after dispersing the toner material in the aqueous medium, the compound containing an active hydrogen group is added to initiate the reaction from the interface of the particle. In this case, a modified polyester formed with the polyester prepolymer is generated preferentially at a surface of a toner particle to be produced, and as a result, it is possible to provide a concentration gradient within the particle.

Examples of the dispersant for emulsifying and dispersing the oil phase, in which the toner material is dispersed, in the liquid containing water, include; anionic surfactants such as alkyl benzene sulfonic acid salts, α-olefin sulfonic acid salts and phosphoric acid esters; amine salts such as alkyl amine salts, amino alcohol fatty acid derivatives, polyamine fatty acid derivatives and imidazoline; quaternary ammonium salt cationic surfactants such as alkyltrimethylammonium salts, dialkyldimethylammonium salts, alkyl dimethyl benzyl ammonium salts, pyridinium salts, alkyl isoquinolinium salts and benzethonium chloride; nonionic surfactants such as fatty acid amide derivatives and polyhydric alcohol derivatives; and amphoteric surfactants such as alanine, dodecyldi(aminoethyl)glycine, di(octylaminoethyl)glycine and N-alkyl-N,N-dimethylammonium betaine.

Also, a fluoroalkyl group-containing surfactant can exhibit its dispersing effects even in a small amount. Preferable examples of the fluoroalkyl group-containing anionic surfactant include C2-C10 fluoroalkyl carboxylic acid or a metal salt thereof, disodium perfluorooctane sulfonyl glutamate, sodium 3-[ω-fluoroalkyl(C6-C11)oxy)-1-alkyl(C3-C4) sulfonate, sodium 3-[ωfluoroalkanoyl(C6-C8)-N-ethylamino]-1-propanesulfonate, fluoroalkyl(C11-C20) carboxylic acid or a metal salt thereof, perfluoroalkylcarboxylic acid(C7-C13) or a metal salt thereof, perfluoroalkyl(C4-C12)sulfonate or a metal salt thereof, perfluorooctanesulfonic acid diethanol amide, N-propyl-N-(2-hydroxyethyl)perfluorooctanesulfone amide, perfluoroalkyl(C6-C10)sulfoneamidepropyltrimethylammonium salt, a salt of perfluoroalkyl(C6-C10)-N-ethylsulfonylglycin and monoperfluoroalkyl(C6-C16) ethylphosphate.

As for the fluoroalkyl group-containing surfactant, commercial products can be used. Examples of product names of the products include: SURFLON S-111, S-112, S-113 (manufactured by Asahi Glass Co., Ltd.); FRORARD FC-93, FC-95, FC-98, FC-129 (manufactured by Sumitomo 3M Ltd.); UNIDYNE DS-101, DS-102 (manufactured by Daikin Industries, Ltd.); MEGAFACEF-110, F-120, F-113, F-191, F-812, F-833 (manufactured by DIC Corporation); EFTOP EF-102, 103, 104, 105, 112, 123A, 123B, 306A, 501, 201, 204 (manufactured by Tohchem Products Co., Ltd.); and FUTARGENT F-100, F150 (manufactured by NEOS COMPANY LIMITED).

Examples of the cationic surfactant include an aliphatic primary, secondary or tertiary amine acid containing a fluoroalkyl group, aliphatic quaternary ammonium salt such as perfluoroalkyl(C6-C10)sulfonic amide propyl trimethyl ammonium salt, benzalkonium salt, benzetonium chloride, pyridinium salt and imidazolinium salt. As for the cationic surfactant, commercial products can be used. Examples of product names of the products include: SURFLON S-121 (manufactured by Asahi Glass Co., Ltd.); FRORARD FC-135 (manufactured by Sumitomo 3M Ltd.); UNIDYNE DS-202 (manufactured by Daikin Industries, Ltd.); MEGAFACE F-150, F-824 (manufactured by DIC Corporation); EFTOP EF-132 (manufactured by Tohchem Products Co., Ltd.); and FUTARGENT F-300 (manufactured by NEOS COMPANY LIMITED).

As for a water-insoluble inorganic compound dispersant, tricalcium phosphate, calcium carbonate, titanium oxide, colloidal silica, and hydroxyapatite can be used.

The dispersed droplets may be, moreover, stabilized with polymer protective colloid or water-insoluble organic particles. Examples of the dispersion stabilizer for use include: acids such as acrylic acid, methacrylic acid, α-cyanoacrylic acid, α-cyanomethacrylic acid, itaconic acid, crotonic acid, fumaric acid, maleic acid and maleic anhydride; (meth)acryl monomer containing a hydroxyl group, such as β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycol monoacrylate, diethylene glycol monomethacrylate, glycerin monoacrylate, glycerin monomethacrylate, N-methylol acryl amide, and N-methylol methacryl amide; vinyl alcohol or ethers with vinyl alcohol, such as vinyl methyl ether, vinyl ethyl ether, and vinyl propyl ether; ester of vinyl alcohol and a compound containing a carboxyl group, such as vinyl acetate, vinyl propionate, and vinyl butyrate; acryl amides, such as acryl amide, methacryl amide, diacetone acryl amide or methylol compounds of the preceding amides; acid chlorides, such as acrylic acid chloride, and methacrylic acid chloride; a homopolymer or copolymer containing a nitrogen atom or its heterocycle, such as vinyl pyridine, vinyl pyrrolidone, vinyl imidazole, and ethylene imine; polyoxyethylenes, such as polyoxy ethylene, polyoxypropylene, polyoxy ethylene alkyl amine, polyoxypropylene alkyl amine, polyoxyethylene alkyl amide, polyoxypropylene alkyl amide, polyoxyethylene nonylphenyl ether, polyoxyethylene laurylphenyl ether, polyoxyethylene stearylphenyl ester, and polyoxyethylene nonylphenyl ester; and celluloses such as methyl cellulose, hydroxyethyl cellulose, and hydroxypropyl cellulose.

When an acid- or alkali-soluble compound (e.g., calcium phosphate) is used as a dispersion stabilizer, the calcium phosphate used is dissolved with an acid (e.g., hydrochloric acid), followed by washing with water, to thereby remove it from the formed fine particles (toner particles). Also, the calcium phosphate may be removed through enzymatic decomposition.

Alternatively, the dispersing agent used may remain on the surfaces of the toner particles. The dispersing agent is, however, preferably removed through washing in terms of chargeability of the resulting toner.

In order to reduce the viscosity of the toner composition, moreover, a solvent, in which modified polyester obtained through reaction of polyester prepolymers can be dissolved, can be used. Use of the solvent is preferable, as the resulting toner has a sharp particle size distribution.

The solvent is preferably volatile, and having a boiling point of lower than 100° C., because it can be easily removed. The solvent is appropriately selected depending on the intended purpose without any restriction, and examples thereof include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. These may be used independently, or in combination.

Among them, the aromatic solvent such as toluene and xylene, and halogenated hydrocarbon such as methylene chloride, 1,2-dichloroethane, chloroform, and carbon tetrachloride are particularly preferable.

An amount of the solvent is preferably 0 parts by mass to 300 parts by mass, more preferably 0 parts by mass to 100 parts by mass, and even more preferably 25 parts by mass to 70 parts by mass, relative to 100 parts by mass of the polyester prepolymer. When the solvent is used, the solvent is removed by heating under normal pressure or reduced pressure after the elongation and/or crosslink reaction.

The duration for the elongation and/or crosslink reaction is selected depending on the reactivity between the polyester prepolymer and the compound containing an active hydrogen group, but it is typically 10 minutes to 40 hours, preferably 30 minutes to 24 hours. The reaction temperature is typically 0° C. to 100° C., preferably 10° C. to 50° C. A conventional catalyst can be moreover used for the elongation and/or crosslink reaction, if necessary. Specific examples of the catalyst include tertiary amine (e.g., triethylamine), and imidazole.

In order to remove the organic solvent from the obtained emulsified dispersion liquid, the following method can be employed. The method includes gradually heating the entire system to completely evaporate the organic solvent contained in the droplets. Alternatively, the emulsified dispersion liquid is sprayed in a dry atmosphere to completely remove the water-insoluble organic solvent contained in the droplets to form toner particles, at the same time, evaporating and removing the aqueous dispersant. As for the dry atmosphere to which the emulsified dispersion liquid is sprayed, heated gas (e.g., air, nitrogen, carbon dioxide and combustion gas), particularly various air flow heated at the temperature equal to or higher than the highest boiling point of the solvent are generally used. A treatment of a short period using a spray drier, belt dryer, or rotary kiln quality can sufficiently achieve the intended quality.

In the case where the dispersed elements have a wide particle size distribution during the emulsifying and dispersing, and the resulting particles are washed and dried with keeping such particle size distribution, the particle size distribution can be adjusted to the intended particle size distribution by classification.

As the classification operation performed in the liquid, fine particles can be removed by means of cyclone, a decanter, or centrifugal separator. Of course, the classification may be performed after attaining the particles as powder as a result of the drying. It is however more preferred that the classification be performed in the liquid in terms of the efficiency. The collected unnecessary fine particles or coarse particles are return to the kneading process to use them for the formation of particles. In this recycling operation, the fine particles or coarse particles may be in the wet state.

The used dispersant is preferably removed from the dispersion liquid as much as possible, and the removal of the dispersant is preferably performed at the same time as the operation of the classification.

By mixing the obtained and dried toner powder with other particles such as releasing agent particles, charge controlling particles, plasticizer particles, and colorant particles, or applying a mechanical impact to the powder mixture, the aforementioned other particles are fixed and fused on surfaces of the obtained composite particles, to thereby prevent the other particles from detaching from the surfaces of the composite particles.

A specific method for mixing or applying the impact include a method for applying impulse force to a mixture by a blade rotating at high speed, and a method for adding a mixture into a high-speed air flow and the speed of the flow is accelerated to thereby make the particles crash into other particles, or make the composite particles crush into an appropriate impact board. Examples of the device for use include ANGMILL (product of Hosokawa Micron Corporation), an apparatus produced by modifying I-type mill (product of Nippon Pneumatic Mfg. Co., Ltd.) to reduce the pulverizing air pressure, a hybridization system (product of Nara Machinery Co., Ltd.), a kryptron system (product of Kawasaki Heavy Industries, Ltd.) and an automatic mortar.

### <External Additive>

The toner may contain an external additive for aiding flowability, developing ability, or charging ability of the toner.

As for the external additive, inorganic particles are preferably used. The primary particle diameters of the inorganic particles are preferably 5 nm to 2 μm, more preferably 5 nm to 500 nm. The BET specific surface area thereof is preferably 20 m²/g to 500 m²/g.

An amount of the inorganic particles is preferably 0.01% by mass to 5% by mass, more preferably 0.01% by mass to 2.0% by mass, relative to the toner. Examples of the inorganic particles include silica, alumina, titanium oxide, barium titanate, magnesium titanate, calcium titanate, strontium titanate, zinc oxide, tin oxide, quartz sand, clay, mica, wollastonite, diatomaceous earth, chromic oxide, cerium oxide, red iron oxide, antimony trioxide, magnesium oxide, zirconium oxide, barium sulfate, barium carbonate, calcium carbonate, silicon carbide, and silicon nitride.

Other examples of the external additive include polymer particles, such as particles produced by soap-free emulsification polymerization, suspension polymerization, or dispersion polymerization (e.g. polystyrene particles, (meth)acrylic acid ester copolymer particles); polymer particles produced by polymerization condensation such as silicone particles, benzoguanamine particles, and nylon particles; and polymer particles of thermoset resins.

The external additive for imparting flowability can be subjected to a surface treatment to increase hydrophobicity, and to prevent deterioration of flow properties or charging properties in a high humidity environment.

Examples of the surface treating agent include a silane coupling agent, a sililating agent, a silane coupling agent containing a fluoroalkyl group, an organic titanate-based coupling agent, an aluminum-based coupling agent, silicone oil, and modified silicone oil.

Examples of the cleaning improving agent for removing the developer remained on the photoconductor and the primary transfer member after the transferring include: fatty acid metal salts such as zinc stearate, calcium stearate, stearic acid; and polymer particles produced by soap-free emulsification polymerization, such as polymethyl methacrylate particles, and polystyrene particles. As for the polymer particles, polymer particles having a relatively narrow particle size distribution and the volume average particle diameter of 0.01 μm to 1 μm are preferably used.

### (Developer)

The toner of the present invention can be used as a one-component magnetic or non-magnetic developer that does not use a carrier. The toner of the invention can be also used for a two-component developer that contains a carrier.

In the case where the toner is used for a two-component developer, the toner is used by mixing with a magnetic carrier. As a ratio of the carrier to the toner in the developer, the toner is contained in the developer preferably in an amount of 1 part by mass to 10 parts by mass relative to 100 parts by mass of the carrier. As for the magnetic carrier, conventional carriers, such as iron powder, ferrite powder, magnetite powder, and magnetic resin carrier having the particle diameter of about 20 μm to 200 μm, can be used.

The carrier particles constituting the carrier may be coated with a coating resin. Examples of the coating resin include: an amide resin such as a urea-formaldehyde resin, a melamine resin, a benzoguanamine resin, a urea resin, a polyamide resin; an epoxy resin; a polyvinyl resin such as an acrylic resin, polymethyl methacrylate, polyacrylonitrile, polyvinyl acetate, polyvinyl alcohol, and polyvinyl butyral; a polyvinylidene resin; a polystyrene resin such as polystyrene, a styrene-acryl copolymer resin; a halogenated olefin resin such as polyvinyl chloride; a polyester resin such as polyethylene terephthalate, and polybutylene terephthalate; and others such as a polycarbonate resin, polyethylene, polyvinyl fluoride, polyvinylidene fluoride, polytrifluoroethylene, polyhexafluoropropylene, a copolymer of vinylidene fluoride and an acrylic monomer, a copolymer of vinylidene fluoride and vinyl fluoride, a terpolymer of tetrafluoroethylene, vinylidene fluoride, and a non-fluoromonomer, and a silicone resin.

The coating resin may contain electric conductive powder (e.g., metal powder, carbon black, titanium oxide, tin oxide, and zinc oxide), if necessary. The electric conductive powder preferably has the average particle diameter of 1 μm or smaller. When the average particle diameter of the electric conductive powder is larger than 1 μm, it is difficult to control electric resistance.

Measuring methods and values of the properties of the toner obtained in the aforementioned manner will be explained next.

In the present embodiment, the particle size distribution of the toner is measured by a coulter counter method.

As for a measuring device of a particle size distribution according to the coulter counter method, Coulter Counter TA-II and Coulter Multisizer II (both manufactured by Beckman Coulter, Inc.) are listed.

In the present embodiment, the Coulter Counter TA-II measuring device is connected with a PC-9801 personal computer (manufactured by NEC Corporation) via an interface (of I-JUSE) outputting a number distribution and volume distribution, to thereby perform a measurement of a particle size distribution.

Specifically, 0.1 mL to 5 mL of a surfactant (preferably alkyl benzene sulfonate) was added as a dispersant to 100 mL to 150 mL of an electrolyte. Note that, the electrolyte is an about 1% by mass aqueous solution prepared by using a primary sodium chloride, and for example, ISOTON-II (of Beckman Coulter, Inc.) is used as the electrolyte. Next, to the resulting mixture, 2 mg to 20 mg of a sample is added and suspended, and the mixture is dispersed by means of an ultrasonic wave disperser for 1 minute to 3 minutes. The volume and number of the toner particles are measured from the obtained dispersion liquid using the aforementioned measuring device with an aperture of 100 μm, and then the volume distribution and number distribution of the toner are calculated.

Note that, as a channel, the following 13 channels are used: 2.00 μm or larger, but smaller than 2.52 μm; 2.52 μm or larger, but smaller than 3.17 μm; 3.17 μm or larger, but smaller than 4.00 μm; 4.00 μm or larger, but smaller than 5.04 μm; 5.04 μm or larger, but smaller than 6.35 μm; 6.35 μm or larger, but smaller than 8.00 μm; 8.00 μm or larger, but smaller than 10.08 μm; 10.08 μm or larger, but smaller than 12.70 μm; 12.70 μm or larger, but smaller than 16.00 μm; 16.00 μm or larger, but smaller than 20.20 μm; 20.20 μm or larger, but smaller than 25.40 μm; 25.40 μm or larger, but smaller than 32.00 μm; and 32.00 μm or larger, but smaller than 40.30 μm. The target particles for the measurement are particles having the diameters of 2.00 μm or larger, but smaller than 40.30 μm.

The volume average particle diameter of the toner is preferably 3 μm to 7 μm, and a ratio of the volume average particle diameter of the toner to the number average particle diameter of the toner is preferably 1.2 or smaller. It is moreover preferred that the toner contain the particles having the particle diameters of 2 μm or smaller in an amount of 1% by number to 10% by number.

The acid value of the toner of the present embodiment is measured by the method according to JIS K0070-1992.

Specifically, 0.5 g of sample (soluble matter in ethyl acetate: 0.3 g) is added to 120 mL of toluene, and the resultant mixture is stirred for about 10 hours at 23° C. for dissolution. Next, ethanol (30 mL) is added thereto to prepare a sample solution. Notably, when the sample is not dissolved in toluene, another solvent such as dioxane or tetrahydrofuran is used. Then, a potentiometric automatic titrator (DL-53 Titrator, manufactured by Mettler-Toledo K.K.) and an electrode DG113-SC (product of Mettler-Toledo K.K.) are used to measure the acid value at 23° C. The measurements are analyzed with analysis software LabX Light Version 1.00.000.

Note that, the calibration for this apparatus is performed using a solvent mixture of toluene (120 mL) and ethanol (30 mL).

The measurement conditions are the same as those set for measuring the hydroxyl value.

The acid value can be measured in the above-described manner. Specifically, the sample solution is titrated with a pre-standardized 0.1N potassium hydroxide/alcohol solution and then the acid value is calculated from the titer using the equation: acid value (KOHmg/g)=titer (mL)×N×56.1 (mg/mL)/mass of sample (g), where N is a factor of 0.1N potassium hydroxide/alcohol solution.

The acid value of the toner is an important indicator for the low temperature fixing ability and hot offset resistance of the toner, and is derived from the terminal carboxyl group of the unmodified polyester resin. The acid value of the toner is preferably 0.5 mgKOH/g to 40 mgKOH/g for controlling the low temperature fixing ability (e.g., minimum fixing temperature and hot offset occurring temperature). When the acid value of the toner is higher than 40 mgKOH/g, an elongation reaction and/or crosslink reaction of the reactive modified polyester resin is insufficiently performed, which may lead to insufficient hot offset resistance of the resulting toner. When the acid value of the toner is lower than 0.5 mgKOH/g, an effect of improving the dispersion stability during the production owing to the base may not be attained, or the elongation reaction and/or crosslink reaction are very easily progressed, which may reduce the production stability.

In the present embodiment, the glass transition temperature of the toner can be measured, for example, by a differential scanning calorimeter (DSC) system (DSC-60, manufactured by Shimadzu Corporation).

Specifically, first, an aluminum sample container charged with about 5 mg of a sample is placed on a holder unit, and the holder unit is then set in an electric furnace. Next, the sample is heated from 10° C. to 150° C. at the heating rate of 10° C./min to determine glass transition temperature of the toner, which is T1. After the first heating, the sample is left to stand for 10 minutes at 150° C., and then cooled to 10° C. at the cooling rate of 10° C./min, followed by standing for 10 minutes. The sample is again heated at the heating rate of 10° C./min for a second time to determine glass transition temperature of the toner, which is measured as T2. The glass transition temperature of the toner is calculated from a contact point of a tangent line of an endothermic curve adjacent to the glass transition temperature and a base line, using an analysis program in the system.

The glass transition temperature Tg1st determined from the first heating is derived from the glass transition temperature of the crystalline polyester used as a resin having the lowest glass transition temperature among resins for forming the toner. When the crystalline polyester and the non-crystalline polyester partially or entirely become compatible to each other during the aforementioned production process, however, the Tg1st significantly lowers. When the Tg1st is lower than 45° C., the heat resistant storage stability of the toner deteriorates. When the Tg1st of the toner is higher than 65° C., the temperature at which the toner starts melting becomes high, so that the low temperature fixing ability of the toner cannot be attained. Accordingly, the Tg1st of the toner is controlled to fall into the range of 45° C. to 65° C.

The glass transition temperature determined from the second heating, namely, the glass transition temperature Tg2nd after the thermofusion of the toner, is not derived from materials for forming the toner, but is a characteristic temperature newly generated as a result of compatibility of resins during the aforementioned production process. When the Tg2nd is lower than 25° C., the compatibility of the resins is excessive during the fixing, which may deteriorate the separation ability of the toner at the time of the fixing. When the Tg2nd is higher than 35° C., the compatibility of the resins is insufficient during the fixing, which may deteriorate low temperature fixing ability of the toner. Accordingly, Tg2nd of the toner is controlled to fall into the range of 25° C. to 35° C.

In the present embodiment, the ½ flow onset temperature T½ of the toner can be measured by means of an elevated flow tester (CFT500, manufactured by Shimadzu Corporation). Specifically, the ½ flow onset temperature T½ can be determined from a flow curve obtained by melting and flowing a sample, and is a temperature at which the stroke variation from the meltflow onset temperature to the meltflow endset temperature becomes ½.

The ½ flow onset temperature T½ of the toner indicates decrease in the viscosity of the resin. When the ½ flow onset temperature T½ is lower than 120° C., the separation ability of the toner is deteriorated at the time of the fixing. When the ½ flow onset temperature T½ is higher than 135° C., the softening onset temperature of the toner is high, so that the low temperature fixing ability of the toner cannot be attained. Therefore, T½ of the toner is controlled to fall in the range of 120° C. to 135° C.

In the present embodiment, the intensity ratio (P2850/P828) of the toner in accordance with FTIR-ATR can be measured, for example, by means of a FTIR device (Avatar 370, manufactured by Thermo Fisher Scientific K.K.).

Specifically, as a sample, 3 g of a toner is placed in an automatic briquetting press (Type M No. 50 BRP-E, Maekawa Testing Machine Mfg. Co. Ltd.) and pressed for 1 minute with load of 6 t to thereby prepare a pellet having a diameter of 40 mm (thickness: about 2 mm). A surface of the resulting toner pellet is measured by the aforementioned FTIR device. The conditions for the measurement are as follows:

### Measurement Conditions

Measurement range: 4,000 [cm⁻¹] to 675 [cm⁻¹]

Material of window used: Ge

Gain 4: 4.0

Mirror speed: 0.6327

Aperture: 100

Beam splitter: KBr

The intensity ratio (P2850/P828) of the obtained peak (2,850 cm⁻¹) derived from the wax and crystalline polyester resin to the peak (828 cm⁻¹) derived from the binder resin is determined as a relative amount of wax, and a relative amount of the crystalline polyester resin adjacent to the surfaces of the toner particles. As for the value, the average value of the values obtained by measuring 4 times by changing the measuring spot is adapted.

The index related to the uneven distribution of the crystalline polyester and releasing agent in the area adjacent to the surfaces of the toner particles can be attained from the peak intensity ratio of the intensity of the peak derived the crystalline polyester resin and releasing agent to the intensity of the peak derived from the binder resin as measured in FTIR-ATR. When the peak intensity ratio is low, it indicates that an amount of the crystalline polyester and releasing agent present around a surface of a toner particle is low. If the peak intensity ratio is less than 0.10, the separation ability of the toner is insufficient. When the peak intensity ratio is high, it indicates that an amount of the crystalline polyester and releasing agent present in the area around a surface of a toner particle is large. If the peak intensity ratio is greater than 0.20, heat resistant storage stability of the resulting toner is insufficient. When a large amount of the releasing agent is present in the area adjacent to a surface of a toner particle, releasing ability of the toner improves, but on the other hand, heat resistant storage stability deteriorates as the releasing agent tends to deposit on surrounding members. When a large amount of the crystalline polyester is present in an area adjacent to a surface of a toner particle, heat resistant storage stability deteriorates. The reason for such deterioration is considered as follows. The crystalline polyester generally has glass transition temperature of 0° C. or lower, and crystallinity degree of 100% or lower, and therefore the dispersed crystalline polyester has a non-crystalline component having glass transition temperature of 0° C. or lower. In the case where the crystalline polyester having such component is present in an area adjacent to a surface of a toner particle, heat resistant storage stability of the toner becomes insufficient. In order to improve heat resistant storage stability with maintaining separation ability, the aforementioned peak intensity ratio derived from the crystalline resin and releasing agent measured by FTIR-ATR is adjusted to fall into the range of 0.10 to 0.20.

### EXAMPLES

The toner will be more specifically explained through Examples, but these Examples shall not be construed as to limit the scope of the present invention. In the descriptions below, moreover, “part(s)” denotes “part(s) by mass,” unless otherwise stated.

Various properties of the toner and a molecular weight distribution of the crystalline polyester resin were measured in the following manners in Examples.

### <Glass Transition Temperature of Toner>

The glass transition temperature of the toner was measured by a differential scanning calorimeter (DSC) system (DSC-60, manufactured by Shimadzu Corporation).

First, an aluminum sample container charged with 5 mg of a sample was placed on a holder unit, and the holder unit is then set in an electric furnace. Next, the sample was heated from 10° C. to 150° C. at the heating rate of 10° C./min to determine glass transition temperature of the toner, which was T1. After the first heating, the sample was left to stand for 10 minutes at 150° C., and then cooled to 10° C. at the cooling rate of 10° C./min, followed by standing for 10 minutes. The sample was again heated at the heating rate of 10° C./min for a second time to determine glass transition temperature of the toner, which was measured as T2. The glass transition temperature of the toner was calculated from a contact point of a tangent line of an endothermic curve adjacent to the glass transition temperature and a base line, using an analysis program in the system.

The glass transition temperature Tg1st determined from the first heating is derived from the glass transition temperature of the crystalline polyester used as a resin having the lowest glass transition temperature among resins for forming the toner.

The glass transition temperature determined from the second heating, namely, the glass transition temperature Tg2nd after the thermofusion of the toner, is not derived from materials for forming the toner, but is a characteristic temperature newly generated as a result of compatibility of resins during the aforementioned production process.

<½ Flow Onset Temperature T½ of Toner>

The ½ flow onset temperature T½ of the toner was measured by means of an elevated flow tester (CFT500, manufactured by Shimadzu Corporation).

Specifically, the ½ flow onset temperature T½ can be determined from a flow curve obtained by melting and flowing a sample, and is a temperature at which the stroke variation from the meltflow onset temperature to the meltflow endset temperature becomes ½.

The ½ flow onset temperature T½ of the toner indicates decrease in the viscosity of the resin.

<Peak Intensity Ratio Derived from Crystalline Polyester Resin and Releasing Agent Measured by FTIR-ATR>

The intensity ratio (P2850/P828) of the toner in accordance with FTIR-ATR was measured by means of a FTIR device (Avatar 370, manufactured by Thermo Fisher Scientific K.K.).

First, as a sample, 3 g of a toner was placed in an automatic briquetting press (Type M No. 50 BRP-E, Maekawa Testing Machine Mfg. Co. Ltd.) and pressed for 1 minute with load of 6 t to thereby prepare a pellet having a diameter of 40 mm (thickness: 2 mm). A surface of the resulting toner pellet was measured by the aforementioned FTIR device. The conditions for the measurement were as follows:

### Measurement Conditions

Measurement range: 4,000 [cm⁻¹] to 675 [cm⁻¹]

Material of window used: Ge

Gain 4: 4.0

Mirror speed: 0.6327

Aperture: 100

Beam splitter: KBr

The intensity ratio (P2850/P828) of the obtained peak (2,850 cm⁻¹) derived from the wax and crystalline polyester resin to the peak (828 cm⁻¹) derived from the binder resin was determined as a relative amount of wax, and a relative amount of the crystalline polyester resin adjacent to the surfaces of the toner particles. As for the value, the average value of the values obtained by measuring 4 times by changing the measuring spot was adapted.

### <Molecular Weight Distribution of Crystalline Polyester Resin>

The molecular weight distribution was measured by means of a gel permeation chromatography (GPC) measuring device (GPC-8220GPC, manufactured by TOSOH CORPORATION), under the following conditions.

Column: TSKgel SuperHZM-H, 15 cm, three connected columns (TOSOH CORPORATION)

Temperature: 40° C.

Solvent: tetrahydrofuran (THF)

Flow rate: 0.35 mL/min

Sample: 0.4 mL of a 0.15% sample to be supplied

As for the pretreatment of the sample, the sample was dissolved in tetrahydrofuran (THF) (containing a stabilizer, manufactured by Wako Chemical Industries, Ltd.) to give a concentration of 0.15% by mass, the resulting solution was then filtered through a filter having a pore size of 0.2 μm, and the filtrate from the filtration was used as a sample. The measurement was performed by supplying 100 μL of the tetrahydrofuran (THF) sample solution. For the measurement of the molecular weight distribution of the sample, a molecular weight distribution of the sample was calculated from the relationship between the logarithmic value of the calibration curve prepared from a several monodispersible polystyrene standard samples and the number of counts. As the standard polystyrene samples for preparing the calibration curve, Showdex STANDARD Std. Nos. S-7300, S-210, S-390, S-875, S-1980, S-10.9, S-629, S-3.0, and S-0.580 of SHOWA DENKO K.K., and toluene were used. As the detector, a refractive index (RI) detector was used.

### <Synthesis of Crystalline Polyester Resin 1>

A 5 L four-neck flask equipped with a nitrogen-introducing pipe, a drainpipe, a stirrer and a thermocouple was charged with 1,10-decanedioic acid (2,320 g), 1,8-octanediol (2,530 g) and hydroquinone (5.0 g), followed by reaction at 180° C. for 8 hours. Thereafter, the reaction mixture was further heated to 200° C., and allowed to react for 4 hours, followed by reacting for another 2 hours at 8.3 kPa, to thereby obtain Crystalline Polyester Resin 1.

Crystalline Polyester Resin 1 had the endothermic peak temperature (T2-cp) of 70° C., where the T2-cp was calculated from the second heating in the measurement of DSC, the endothermic shoulder temperature 1 (T2-cs1) of 65° C., the endothermic shoulder temperature 2 (T2-cs2) of 73° C., the number average molecular weight of 3,000, and the weight average molecular weight of 12,000.

### <Synthesis of Crystalline Polyester Resin 2>

A 5 L four-neck flask equipped with a nitrogen-introducing pipe, a drainpipe, a stirrer and a thermocouple was charged with 1,10-adipic acid (2,320 g), 1,5-pentanediol (2,880 g) and hydroquinone (4.9 g), followed by reaction at 180° C. for 10 hours. Thereafter, the reaction mixture was further heated to 200° C., and allowed to react for 3 hours, followed by reacting for another 2 hours at 8.3 kPa, to thereby obtain Crystalline Polyester Resin 2.

The obtained Crystalline Polyester Resin 2 had the endothermic peak temperature (T2-cp) of 58° C., where the T2-cp was calculated from the second heating in the measurement of DSC, the endothermic shoulder temperature 1 (T2-cs1) of 40° C., the endothermic shoulder temperature 2 (T2-cs2) of 65° C., the number average molecular weight of 2,500, and the weight average molecular weight of 12,000.

### <Synthesis of Non-Crystalline Polyester (Low Molecular Polyester) 1>

A 5 L four-neck flask equipped with a nitrogen-introducing pipe, a drainpipe, a stirrer and a thermocouple was charged with bisphenol A ethylene oxide 2 mole adduct (229 parts), bisphenol A propylene oxide 3 mole adduct (529 parts), terephthalic acid (208 parts), adipic acid (46 parts) and dibutyl tin oxide (2 parts). The resulting mixture was reacted for 7 hours at 230° C. under normal pressure, followed by reacted for 4 hours under the reduced pressure of 10 mmHg to 15 mmHg. To the resulting reaction mixture, 44 parts of trimellitic anhydride was added, and the resulting mixture was allowed to react for 2 hours at 180° C. under the normal pressure, to thereby obtain Non-Crystalline Polyester 1.

Non-Crystalline Polyester 1 had the number average molecular weight of 2,400, the weight average molecular weight of 6,300, the glass transition temperature (Tg) of 43° C., and the acid value of 28 mgKOH/g.

### <Preparation of Intermediate Polyester>

A reaction vessel equipped with a condenser, a stirrer and a nitrogen-introducing pipe was charged with 682 parts of bisphenol A ethylene oxide 2 mole adduct, 81 parts of bisphenol A propylene oxide 2 mole adduct, 283 parts of terephthalic acid, 22 parts of trimellitic acid, and 2 parts of dibutyl tin oxide, and the resulting mixture was allowed to react for 8 hours at 230° C. under normal pressure, followed by reacted for 5 hours under the reduced pressure of 10 mmHg to 15 mmHg, to thereby obtain Intermediate Polyester 1.

Intermediate Polyester 1 had the number average molecular weight of 2,100, the weight average molecular weight of 9,500, the glass transition temperature (Tg) of 55° C., the acid value of 0.5 mgKOH/g, and the hydroxyl value of 51 mgKOH/g.

### <Synthesis of Polyester Prepolymer 1>

A reaction vessel equipped with a condenser, a stirrer and a nitrogen-introducing pipe was charged with 410 parts of Intermediate Polyester 1, 89 parts of isophorone diisocyanate, and 500 parts of ethyl acetate, and the resulting mixture was allowed to react for 5 hours at 100° C., to thereby obtain Prepolymer 1. Prepolymer 1 had the free isocyanate rate (% by mass) of 1.53%.

### <Synthesis of Non-Crystalline Polyester Resin 2>

A two-neck flask, which had been heated and dried, was charged with raw materials including 780 parts by mole of polyoxypropylene(2,2)-2,2-bis(4-hydroxyphenynpropane, 18 parts by mole of polyoxy ethylene(2,2)-2,2-bis(4-hydroxyphenyl)propane, 47 parts by mole of terephthalic acid, 24 parts by mole of fumaric acid, and 24 parts by mole of n-dodecenyl succinic acid, as well as dibutyl tin oxide as a catalyst, and nitrogen gas was introduced into the flask to maintain the inner atmosphere as inert atmosphere. The mixture in the flask was heated, followed by subjected to a co-condensation polymerization for 12 hours at 230° C. Thereafter, the pressure of the inner atmosphere was gradually reduced at 230° C., to thereby obtain Non-Crystalline Polyester Resin 2. Non-Crystalline Polyester Resin 2 had the number average molecular weight of 6,700, the weight average molecular weight of 17,400, the glass transition temperature (Tg) of 61° C., and the acid value of 14 mgKOH/g.

### <Preparation of Non-Crystalline Polyester Solution 1>

A 2 L-metal container was charged with 125 parts of Non-Crystalline Polyester Resin 2, and 75 parts of ethyl acetate, and the mixture was heated to 65° C. to dissolve Non-Crystalline Polyester Resin 2, followed by quenching the resulting solution in an ice-water bath at the rate of 27° C./min. to thereby obtain Non-Crystalline Polyester Solution 1.

### <Preparation of Non-Crystalline Polyester Solution 2>

A 2 L-metal container was charged with 100 parts of Non-Crystalline Polyester Resin 2, and 100 parts of ethyl acetate, and the mixture was heated to 65° C. to dissolve Non-Crystalline Polyester Resin 2, followed by quenching the resulting solution in an ice-water bath at the rate of 27° C./min. to thereby obtain Non-Crystalline Polyester Solution 2.

### <Preparation of Non-Crystalline Polyester Solution 3>

A 2 L-metal container was charged with 75 parts of Non-Crystalline Polyester Resin 2, and 125 parts of ethyl acetate, and the mixture was heated to 65° C. to dissolve Non-Crystalline Polyester Resin 2, followed by quenching the resulting solution in an ice-water bath at the rate of 27° C./min. to thereby obtain Non-Crystalline Polyester Solution 3.

### <Synthesis of Ketimine>

A reaction vessel equipped with a stirring bar and a thermometer was charged with 170 parts of isophorone diamine and 75 parts of methyl ethyl ketone, and the resulting mixture was allowed to react for 5 hours at 50° C., to thereby obtain Ketimine Compound 1.

Ketimine Compound 1 had the amine value of 418.

### <Synthesis of Master Batch (MB)>

Water (1,200 parts), carbon black (Printex 35, product of Degussa) [DBP oil absorption amount=42 mL/100 mg, pH=9.5] (540 parts) and a polyester resin (1,200 parts) were mixed together with HENSCHEL MIXER (product of Mitsui Mining Co., Ltd). The resultant mixture was kneaded at 150° C. for 30 minutes with a two-roller mill, and then rolled, cooled and pulverized with a pulverizer, to thereby obtain Master Batch 1.

### <Synthesis of Wax Dispersant>

An autoclave reaction tank equipped with a thermometer and a stirrer was charged with 600 parts of xylene, and 300 parts of low molecular weight polyethylene (SANWAX LEL-400, manufactured by Sanyo Chemical Industries, Ltd., softening point of 128° C.), and the polyethylene was sufficiently dissolved in the xylene, followed by introducing nitrogen gas to purge the inner atmosphere of the reaction tank. To this, a mixed solution of styrene (2,310 parts), acrylonitrile (270 parts), butyl acrylate (150 parts), di-t-butylperoxyhexahydroterephthalate (78 parts), and xylene (455 parts) was added dropwise over the period of 3 hours at 175° C. to thereby proceed to polymerization, followed by maintaining the same temperature for 30 minutes. Thereafter, the solvent was removed from the mixture to thereby obtain a wax dispersant.

### <Preparation of Oil Phase (Pigment-Wax Dispersion Liquid 1)>

A container equipped with a stirring bar and a thermometer was charged with 378 parts of Non-Crystalline Polyester 1, 110 parts of carnauba wax, 77 parts of the above-synthesized wax dispersant, 22 parts of a charge controlling agent (CCA) (a salicylic acid-based metal complex, E-84 manufactured by ORIENT CHEMICAL INDUSTRIES CO., LTD), and 947 parts of ethyl acetate, the resulting mixture was heated to 80° C. with stirring, and the temperature was maintained at 80° C. for 5 hours, followed by cooling to 30° C. over the period of 1 hour. Next, to the container, 500 parts of Master Batch 1, and 500 parts of ethyl acetate were added, and the resulting mixture was mixed for 1 hour, to thereby obtain Raw Material Solution 1.

Raw Material Solution 1 (1,324 parts) was poured into a separate container, and the carbon black and wax were dispersed with a bead mill (ULTRA VISCOMILL, product of AIMEX CO., Ltd.) under the following conditions: a liquid feed rate of 1 kg/hr, disc circumferential velocity of 6 m/s, 0.5 mm-zirconia beads packed to 80% by volume, and 3 passes. Next, a 65% by mass ethyl acetate solution of Non-Crystalline Polyester 1 (1,042.3 parts) was added thereto, and passed once with the bead mill under the above conditions, to thereby obtain Pigment-Wax Dispersion Liquid 1. Pigment-Wax Dispersion Liquid 1 had the average particle diameter of 0.5 μm, and the solid content (130° C., 30 min.) of 50%.

### <Preparation of Oil Phase (Pigment-Wax Dispersion Liquid 2)>

A container equipped with a stirring bar and a thermometer was charged with 378 parts of Non-Crystalline Polyester 1, 110 parts of carnauba wax, 77 parts of the above-synthesized wax dispersant, 22 parts of a charge controlling agent (CCA) (a salicylic acid-based metal complex, E-84 manufactured by ORIENT CHEMICAL INDUSTRIES CO., LTD), and 947 parts of ethyl acetate, the resulting mixture was heated to 80° C. with stirring, and the temperature was maintained at 80° C. for 5 hours, followed by cooling to 30° C. over the period of 1 hour. Next, to the container, 500 parts of Master Batch 1, and 500 parts of ethyl acetate were added, and the resulting mixture was mixed for 1 hour, to thereby obtain Raw Material Solution 1.

Raw Material Solution 1 (1,324 parts) was poured into a separate container, and the carbon black and wax were dispersed with a bead mill (ULTRA VISCOMILL, product of AIMEX CO., Ltd.) under the following conditions: a liquid feed rate of 1 kg/hr, disc circumferential velocity of 6 m/s, 0.5 mm-zirconia beads packed to 80% by volume, and 5 passes. Next, a 65% by mass ethyl acetate solution of Non-Crystalline Polyester 1 (1,042.3 parts) was added thereto, and passed once with the bead mill under the above conditions, to thereby obtain Pigment-Wax Dispersion Liquid 2. Pigment-Wax Dispersion Liquid 2 had the average particle diameter of 0.35 μm, and the solid content (130° C., 30 min.) of 50%.

### <Preparation of Oil Phase (Pigment-Wax Dispersion Liquid 3)>

A container equipped with a stirring bar and a thermometer was charged with 378 parts of Non-Crystalline Polyester 1, 110 parts of carnauba wax, 71 parts of the above-synthesized wax dispersant, 22 parts of a charge controlling agent (CCA) (a salicylic acid-based metal complex, E-84 manufactured by ORIENT CHEMICAL INDUSTRIES CO., LTD), and 947 parts of ethyl acetate, the resulting mixture was heated to 80° C. with stirring, and the temperature was maintained at 80° C. for 5 hours, followed by cooling to 30° C. over the period of 1 hour. Next, to the container, 500 parts of Master Batch 1, and 500 parts of ethyl acetate were added, and the resulting mixture was mixed for 1 hour, to thereby obtain Raw Material Solution 2.

Raw Material Solution 2 (1,324 parts) was poured into a separate container, and the carbon black and wax were dispersed with a bead mill (ULTRA VISCOMILL, product of AIMEX CO., Ltd.) under the following conditions: a liquid feed rate of 1 kg/hr, disc circumferential velocity of 6 m/s, 0.5 mm-zirconia beads packed to 80% by volume, and 3 passes. Next, a 65% by mass ethyl acetate solution of Non-Crystalline Polyester 1 (1,042.3 parts) was added thereto, and passed once with the bead mill under the above conditions, to thereby obtain Pigment-Wax Dispersion Liquid 3.

Pigment-Wax Dispersion Liquid 3 had the average particle diameter of 0.5 μm, and the solid content (130° C., 30 min.) of 50%.

### <Preparation of Oil Phase (Pigment-Wax Dispersion Liquid 4)>

A container equipped with a stirring bar and a thermometer was charged with 378 parts of Non-Crystalline Polyester 1, 110 parts of carnauba wax, 66 parts of the above-synthesized wax dispersant, 22 parts of a charge controlling agent (CCA) (a salicylic acid-based metal complex, E-84 manufactured by ORIENT CHEMICAL INDUSTRIES CO., LTD), and 947 parts of ethyl acetate, the resulting mixture was heated to 80° C. with stirring, and the temperature was maintained at 80° C. for 5 hours, followed by cooling to 30° C. over the period of 1 hour. Next, to the container, 500 parts of Master Batch 1, and 500 parts of ethyl acetate were added, and the resulting mixture was mixed for 1 hour, to thereby obtain Raw Material Solution 3.

Raw Material Solution 3 (1,324 parts) was poured into a separate container, and the carbon black and wax were dispersed with a bead mill (ULTRA VISCOMILL, product of AIMEX CO., Ltd.) under the following conditions: a liquid feed rate of 1 kg/hr, disc circumferential velocity of 6 m/s, 0.5 mm-zirconia beads packed to 80% by volume, and 3 passes. Next, a 65% by mass ethyl acetate solution of Non-Crystalline Polyester 1 (1,042.3 parts) was added thereto, and passed once with the bead mill under the above conditions, to thereby obtain Pigment-Wax Dispersion Liquid 4. Pigment-Wax Dispersion Liquid 4 had the average particle diameter of 0.5 μm, and the solid content (130° C., 30 min.) of 50%.

### <Preparation of Oil Phase (Pigment-Wax Dispersion Liquid 5)>

A container equipped with a stirring bar and a thermometer was charged with 378 parts of Non-Crystalline Polyester 1, 110 parts of carnauba wax, 55 parts of the above-synthesized wax dispersant, 22 parts of a charge controlling agent (CCA) (a salicylic acid-based metal complex, E-84 manufactured by ORIENT CHEMICAL INDUSTRIES CO., LTD), and 947 parts of ethyl acetate, the resulting mixture was heated to 80° C. with stirring, and the temperature was maintained at 80° C. for 5 hours, followed by cooling to 30° C. over the period of 1 hour. Next, to the container, 500 parts of Master Batch 1, and 500 parts of ethyl acetate were added, and the resulting mixture was mixed for 1 hour, to thereby obtain Raw Material Solution 4.

Raw Material Solution 4 (1,324 parts) was poured into a separate container, and the carbon black and wax were dispersed with a bead mill (ULTRA VISCOMILL, product of AIMEX CO., Ltd.) under the following conditions: a liquid feed rate of 1 kg/hr, disc circumferential velocity of 6 m/s, 0.5 mm-zirconia beads packed to 80% by volume, and 3 passes. Next, a 65% by mass ethyl acetate solution of Non-Crystalline Polyester 1 (1,042.3 parts) was added thereto, and passed once with the bead mill under the above conditions, to thereby obtain Pigment-Wax Dispersion Liquid 5 Pigment-Wax Dispersion Liquid 5 had the average particle diameter of 0.5 μm, and the solid content (130° C., 30 min.) of 50%.

### <Preparation of Oil Phase (Pigment-Wax Dispersion Liquid 6)>

A container equipped with a stirring bar and a thermometer was charged with 359 parts of Non-Crystalline Polyester 1, 110 parts of carnauba wax, 77 parts of the above-synthesized wax dispersant, 22 parts of a charge controlling agent (CCA) (a salicylic acid-based metal complex, E-84 manufactured by ORIENT CHEMICAL INDUSTRIES CO., LTD), and 966 parts of ethyl acetate, the resulting mixture was heated to 80° C. with stirring, and the temperature was maintained at 80° C. for 5 hours, followed by cooling to 30° C. over the period of 1 hour. Next, to the container, 500 parts of Master Batch 1, and 500 parts of ethyl acetate were added, and the resulting mixture was mixed for 1 hour, to thereby obtain Raw Material Solution 5.

Raw Material Solution 5 (1,324 parts) was poured into a separate container, and the carbon black and wax were dispersed with a bead mill (ULTRA VISCOMILL, product of AIMEX CO., Ltd.) under the following conditions: a liquid feed rate of 1 kg/hr, disc circumferential velocity of 6 m/s, 0.5 mm-zirconia beads packed to 80% by volume, and 3 passes. Next, a 60% by mass ethyl acetate solution of Non-Crystalline Polyester 1 (1,042.3 parts) was added thereto, and passed once with the bead mill under the above conditions, to thereby obtain Pigment-Wax Dispersion Liquid 6. Pigment-Wax Dispersion Liquid 6 had the average particle diameter of 0.5 μm, and the solid content (130° C., 30 min.) of 52%.

### <Preparation of Oil Phase (Pigment-Wax Dispersion Liquid 7)>

A container equipped with a stirring bar and a thermometer was charged with 359 parts of Non-Crystalline Polyester 1, 110 parts of carnauba wax, 66 parts of the above-synthesized wax dispersant, 22 parts of a charge controlling agent (CCA) (a salicylic acid-based metal complex, E-84 manufactured by ORIENT CHEMICAL INDUSTRIES CO., LTD), and 966 parts of ethyl acetate, the resulting mixture was heated to 80° C. with stirring, and the temperature was maintained at 80° C. for 5 hours, followed by cooling to 30° C. over the period of 1 hour. Next, to the container, 500 parts of Master Batch 1, and 500 parts of ethyl acetate were added, and the resulting mixture was mixed for 1 hour, to thereby obtain Raw Material Solution 6.

Raw Material Solution 6 (1,324 parts) was poured into a separate container, and the carbon black and wax were dispersed with a bead mill (ULTRA VISCOMILL, product of AIMEX CO., Ltd.) under the following conditions: a liquid feed rate of 1 kg/hr, disc circumferential velocity of 6 m/s, 0.5 mm-zirconia beads packed to 80% by volume, and 3 passes. Next, a 65% by mass ethyl acetate solution of Non-Crystalline Polyester 1 (1,042.3 parts) was added thereto, and passed once with the bead mill under the above conditions, to thereby obtain Pigment-Wax Dispersion Liquid 7. Pigment-Wax Dispersion Liquid 7 had the average particle diameter of 0.5 μm, and the solid content (130° C., 30 min.) of 50%.

### <Preparation of Oil Phase (Pigment-Wax Dispersion Liquid 8)>

A container equipped with a stirring bar and a thermometer was charged with 359 parts of Non-Crystalline Polyester 1, 110 parts of carnauba wax, 55 parts of the above-synthesized wax dispersant, 22 parts of a charge controlling agent (CCA) (a salicylic acid-based metal complex, E-84 manufactured by ORIENT CHEMICAL INDUSTRIES CO., LTD), and 966 parts of ethyl acetate, the resulting mixture was heated to 80° C. with stirring, and the temperature was maintained at 80° C. for 5 hours, followed by cooling to 30° C. over the period of 1 hour. Next, to the container, 500 parts of Master Batch 1, and 500 parts of ethyl acetate were added, and the resulting mixture was mixed for 1 hour, to thereby obtain Raw Material Solution 7.

Raw Material Solution 7 (1,324 parts) was poured into a separate container, and the carbon black and wax were dispersed with a bead mill (ULTRA VISCOMILL, product of AIMEX CO., Ltd.) under the following conditions: a liquid feed rate of 1 kg/hr, disc circumferential velocity of 6 m/s, 0.5 mm-zirconia beads packed to 80% by volume, and 3 passes. Next, a 60% by mass ethyl acetate solution of Non-Crystalline Polyester 1 (1,042.3 parts) was added thereto, and passed once with the bead mill under the above conditions, to thereby obtain Pigment-Wax Dispersion Liquid 8. Pigment-Wax Dispersion Liquid 8 had the average particle diameter of 0.5 μm, and the solid content (130° C., 30 min.) of 48%.

### <Preparation of Oil Phase (Pigment-Wax Dispersion Liquid 9)>

A container equipped with a stirring bar and a thermometer was charged with 378 parts of Non-Crystalline Polyester 1, 110 parts of carnauba wax, 33 parts of the above-synthesized wax dispersant, 22 parts of a charge controlling agent (CCA) (a salicylic acid-based metal complex, E-84 manufactured by ORIENT CHEMICAL INDUSTRIES CO., LTD), and 947 parts of ethyl acetate, the resulting mixture was heated to 80° C. with stirring, and the temperature was maintained at 80° C. for 5 hours, followed by cooling to 30° C. over the period of 1 hour. Next, to the container, 500 parts of Master Batch 1, and 500 parts of ethyl acetate were added, and the resulting mixture was mixed for 1 hour, to thereby obtain Raw Material Solution 8.

Raw Material Solution 8 (1,324 parts) was poured into a separate container, and the carbon black and wax were dispersed with a bead mill (ULTRA VISCOMILL, product of AIMEX CO., Ltd.) under the following conditions: a liquid feed rate of 1 kg/hr, disc circumferential velocity of 6 m/s, 0.5 mm-zirconia beads packed to 80% by volume, and 3 passes. Next, a 65% by mass ethyl acetate solution of Non-Crystalline Polyester 1 (1,042.3 parts) was added thereto, and passed once with the bead mill under the above conditions, to thereby obtain Pigment-Wax Dispersion Liquid 9. Pigment-Wax Dispersion Liquid 9 had the average particle diameter of 0.5 μm, and the solid content (130° C., 30 min.) of 50%.

### <Preparation of Oil Phase (Pigment-Wax Dispersion Liquid 10)>

A container equipped with a stirring bar and a thermometer was charged with 378 parts of Non-Crystalline Polyester 1, 110 parts of carnauba wax, 110 parts of the above-synthesized wax dispersant, 22 parts of a charge controlling agent (CCA) (a salicylic acid-based metal complex, E-84 manufactured by ORIENT CHEMICAL INDUSTRIES CO., LTD), and 947 parts of ethyl acetate, the resulting mixture was heated to 80° C. with stirring, and the temperature was maintained at 80° C. for 5 hours, followed by cooling to 30° C. over the period of 1 hour. Next, to the container, 500 parts of Master Batch 1, and 500 parts of ethyl acetate were added, and the resulting mixture was mixed for 1 hour, to thereby obtain Raw Material Solution 9.

Raw Material Solution 9 (1,324 parts) was poured into a separate container, and the carbon black and wax were dispersed with a bead mill (ULTRA VISCOMILL, product of AIMEX CO., Ltd.) under the following conditions: a liquid feed rate of 1 kg/hr, disc circumferential velocity of 6 m/s, 0.5 mm-zirconia beads packed to 80% by volume, and 3 passes. Next, a 65% by mass ethyl acetate solution of Non-Crystalline Polyester 1 (1,042.3 parts) was added thereto, and passed once with the bead mill under the above conditions, to thereby obtain Pigment-Wax Dispersion Liquid 10.

Pigment-Wax Dispersion Liquid 10 had the average particle diameter of 0.5 μm, and the solid content (130° C., 30 min.) of 50%.

### <Preparation of Crystalline Polyester Dispersion Liquid 1>

A 2 L-metal container was charged with 100 g of Crystalline Polyester Resin 1, and 400 g of ethyl acetate, the mixture was heated to 75° C. to dissolve Crystalline Polyester Resin 1, followed by quenching the solution in an ice-water bath at the rate of 27° C./min. To this, 500 mL of glass beads (diameters of 3 mm) were added, and pulverization was performed for 10 hours by means of a batch sand mill (of Kanpe Hapio Co., Ltd.), to thereby obtain Crystalline Polyester Dispersion Liquid 1.

### <Preparation of Crystalline Polyester Dispersion Liquid 2>

A 2 L-metal container was charged with 100 g of Crystalline Polyester Resin 2, and 400 g of ethyl acetate, the mixture was heated to 75° C. to dissolve Crystalline Polyester Resin 2, followed by quenching the solution in an ice-water bath at the rate of 27° C./min. To this, 500 mL of glass beads (diameters of 3 mm) were added, and pulverization was performed for 10 hours by means of a batch sand mill (of Kanpe Hapio Co., Ltd.), to thereby obtain Crystalline Polyester Dispersion Liquid 2.

### <Synthesis of Organic Particle Emulsion>

A reaction vessel equipped with a stirring bar and a thermometer was charged with 683 parts of water, 11 parts of a sodium salt of sulfuric acid ester of methacrylic acid-ethylene oxide adduct (ELEMINOL RS-30, manufactured by Sanyo Chemical Industries, Ltd.), 138 parts of styrene, 138 parts of methacrylic acid, and 1 part of ammonium persulfate, and the resulting mixture was stirred for 15 minutes at 400 rpm, to thereby obtain a white emulsion. The white emulsion was heated until the internal temperature became 75° C., and was allowed to react for 5 hours. To this, 30 parts of a 1% ammonium persulfate aqueous solution was added, followed by aging for 5 hours at 75° C., to thereby obtain Particle Dispersion Liquid 1 (an aqueous dispersion liquid of a vinyl resin (a copolymer of styrene/methacrylic acid/sodium salt of sulfuric acid ester of methacrylic acid ethylene oxide adduct)).

The volume average particle diameter of Particle Dispersion Liquid 1 was measured by LA-920 (of Horiba, Ltd.), and it was 0.14 μm. Part of Particle Dispersion Liquid 1 was dried to separate the resin component.

### <Preparation of Aqueous Phase>

Water (990 parts), Particle Dispersion Liquid 1 (83 parts), a 48.5% aqueous solution of sodium dodecyldiphenyl ether disulfonate (ELEMINOL MON-7, product of Sanyo Chemical Industries Ltd.) (37 parts) and ethyl acetate (90 parts) were mixed together and stirred to obtain an opaque white liquid, which was used as Aqueous Phase 1.

### <Emulsification and Removal of Solvent 1>

A contained was charged with 664 parts of Pigment-Wax Dispersion Liquid 1, 109.4 parts of Prepolymer 1, 73.9 parts of Crystalline Polyester Dispersion Liquid 1, and 4.6 parts of Ketimine Compound 1, and the resulting mixture was mixed for 1 minute at 5,000 rpm by means of TK Homomixer (product of Tokushu Kika Kogyo Co., Ltd.). Thereafter, 1,200 parts of Aqueous Phase 1 was added into the container, and the resulting mixture was mixed for 20 minutes at 13,000 rpm by a TK Homomixer, to thereby obtain Emulsified Slurry 1.

A container equipped with a stirrer and a thermometer was charged with Emulsified Slurry 1, and the solvent was removed from Emulsified Slurry 1 over the period of 8 hours at 30° C., followed by aging for 10 hours at 45° C., to thereby obtain Dispersion Slurry 1.

### <Emulsification and Removal of Solvent 2>

A contained was charged with 664 parts of Pigment-Wax Dispersion Liquid 1, 109.4 parts of Prepolymer 1, 73.9 parts of Crystalline Polyester Dispersion Liquid 1, and 4.6 parts of Ketimine Compound 1, and the resulting mixture was mixed for 1 minute at 5,000 rpm by means of TK Homomixer (product of Tokushu Kika Kogyo Co., Ltd.). Thereafter, 1,200 parts of Aqueous Phase 1 was added into the container, and the resulting mixture was mixed for 20 minutes at 13,000 rpm by a TK Homomixer, to thereby obtain Emulsified Slurry 1.

A container equipped with a stirrer and a thermometer was charged with Emulsified Slurry 1, and the solvent was removed from Emulsified Slurry 1 over the period of 8 hours at 30° C., followed by aging for 20 hours at 45° C., to thereby obtain Dispersion Slurry 2.

### <Emulsification and Removal of Solvent 3>

A contained was charged with 664 parts of Pigment-Wax Dispersion Liquid 1, 109.4 parts of Prepolymer 1, 73.9 parts of Crystalline Polyester Dispersion Liquid 2, and 4.6 parts of Ketimine Compound 1, and the resulting mixture was mixed for 1 minute at 5,000 rpm by means of TK Homomixer (product of Tokushu Kika Kogyo Co., Ltd.). Thereafter, 1,200 parts of Aqueous Phase 1 was added into the container, and the resulting mixture was mixed for 20 minutes at 13,000 rpm by a TK Homomixer, to thereby obtain Emulsified Slurry 2.

A container equipped with a stirrer and a thermometer was charged with Emulsified Slurry 2, and the solvent was removed from Emulsified Slurry 2 over the period of 8 hours at 30° C., followed by aging for 10 hours at 45° C., to thereby obtain Dispersion Slurry 3.

### <Emulsification and Removal of Solvent 4>

A contained was charged with 664 parts of Pigment-Wax Dispersion Liquid 1, 109.4 parts of Prepolymer 1, 73.9 parts of Crystalline Polyester Dispersion Liquid 2, and 4.6 parts of Ketimine Compound 1, and the resulting mixture was mixed for 1 minute at 5,000 rpm by means of TK Homomixer (product of Tokushu Kika Kogyo Co., Ltd.). Thereafter, 1,200 parts of Aqueous Phase 1 was added into the container, and the resulting mixture was mixed for 20 minutes at 13,000 rpm by a TK Homomixer, to thereby obtain Emulsified Slurry 2.

A container equipped with a stirrer and a thermometer was charged with Emulsified Slurry 2, and the solvent was removed from Emulsified Slurry 2 over the period of 8 hours at 30° C., followed by aging for 20 hours at 45° C., to thereby obtain Dispersion Slurry 4.

### <Emulsification and Removal of Solvent 5>

A contained was charged with 664 parts of Pigment-Wax Dispersion Liquid 2, 109.4 parts of Prepolymer 1, 73.9 parts of Crystalline Polyester Dispersion Liquid 1, and 4.6 parts of Ketimine Compound 1, and the resulting mixture was mixed for 1 minute at 5,000 rpm by means of TK Homomixer (product of Tokushu Kika Kogyo Co., Ltd.). Thereafter, 1,200 parts of Aqueous Phase 1 was added into the container, and the resulting mixture was mixed for 20 minutes at 13,000 rpm by a TK Homomixer, to thereby obtain Emulsified Slurry 3.

A container equipped with a stirrer and a thermometer was charged with Emulsified Slurry 3, and the solvent was removed from Emulsified Slurry 3 over the period of 8 hours at 30° C., followed by aging for 10 hours at 45° C., to thereby obtain Dispersion Slurry 5.

### <Emulsification and Removal of Solvent 6>

A contained was charged with 664 parts of Pigment-Wax Dispersion Liquid 3, 109.4 parts of Prepolymer 1, 73.9 parts of Crystalline Polyester Dispersion Liquid 1, and 4.6 parts of Ketimine Compound 1, and the resulting mixture was mixed for 1 minute at 5,000 rpm by means of TK Homomixer (product of Tokushu Kika Kogyo Co., Ltd.). Thereafter, 1,200 parts of Aqueous Phase 1 was added into the container, and the resulting mixture was mixed for 20 minutes at 13,000 rpm by a TK Homomixer, to thereby obtain Emulsified Slurry 4.

A container equipped with a stirrer and a thermometer was charged with Emulsified Slurry 4, and the solvent was removed from Emulsified Slurry 4 over the period of 8 hours at 30° C., followed by aging for 10 hours at 45° C., to thereby obtain Dispersion Slurry 6.

### <Emulsification and Removal of Solvent 7>

A contained was charged with 664 parts of Pigment-Wax Dispersion Liquid 4, 109.4 parts of Prepolymer 1, 73.9 parts of Crystalline Polyester Dispersion Liquid 1, and 4.6 parts of Ketimine Compound 1, and the resulting mixture was mixed for 1 minute at 5,000 rpm by means of TK Homomixer (product of Tokushu Kika Kogyo Co., Ltd.). Thereafter, 1,200 parts of Aqueous Phase 1 was added into the container, and the resulting mixture was mixed for 20 minutes at 13,000 rpm by a TK Homomixer, to thereby obtain Emulsified Slurry 5.

A container equipped with a stirrer and a thermometer was charged with Emulsified Slurry 5, and the solvent was removed from Emulsified Slurry 5 over the period of 8 hours at 30° C., followed by aging for 10 hours at 45° C., to thereby obtain Dispersion Slurry 7.

### <Emulsification and Removal of Solvent 8>

A contained was charged with 664 parts of Pigment-Wax Dispersion Liquid 5, 109.4 parts of Prepolymer 1, 73.9 parts of Crystalline Polyester Dispersion Liquid 1, and 4.6 parts of Ketimine Compound 1, and the resulting mixture was mixed for 1 minute at 5,000 rpm by means of TK Homomixer (product of Tokushu Kika Kogyo Co., Ltd.). Thereafter, 1,200 parts of Aqueous Phase 1 was added into the container, and the resulting mixture was mixed for 20 minutes at 13,000 rpm by a TK Homomixer, to thereby obtain Emulsified Slurry 6.

A container equipped with a stirrer and a thermometer was charged with Emulsified Slurry 6, and the solvent was removed from Emulsified Slurry 6 over the period of 8 hours at 30° C., followed by aging for 10 hours at 45° C., to thereby obtain Dispersion Slurry 8.

### <Emulsification and Removal of Solvent 9>

A contained was charged with 664 parts of Pigment-Wax Dispersion Liquid 6, 109.4 parts of Non-Crystalline Polyester Solution 1, 73.9 parts of Crystalline Polyester Dispersion Liquid 1, and 4.6 parts of Ketimine Compound 1, and the resulting mixture was mixed for 1 minute at 5,000 rpm by means of TK Homomixer (product of Tokushu Kika Kogyo Co., Ltd.). Thereafter, 1,200 parts of Aqueous Phase 1 was added into the container, and the resulting mixture was mixed for 20 minutes at 13,000 rpm by a TK Homomixer, to thereby obtain Emulsified Slurry 7.

A container equipped with a stirrer and a thermometer was charged with Emulsified Slurry 7, and the solvent was removed from Emulsified Slurry 7 over the period of 8 hours at 30° C., followed by aging for 10 hours at 45° C., to thereby obtain Dispersion Slurry 9.

### <Emulsification and Removal of Solvent 10>

A contained was charged with 664 parts of Pigment-Wax Dispersion Liquid 7, 109.4 parts of Non-Crystalline Polyester Solution 2, 73.9 parts of Crystalline Polyester Dispersion Liquid 1, and 4.6 parts of Ketimine Compound 1, and the resulting mixture was mixed for 1 minute at 5,000 rpm by means of TK Homomixer (product of Tokushu Kika Kogyo Co., Ltd.). Thereafter, 1,200 parts of Aqueous Phase 1 was added into the container, and the resulting mixture was mixed for 20 minutes at 13,000 rpm by a TK Homomixer, to thereby obtain Emulsified Slurry 8.

A container equipped with a stirrer and a thermometer was charged with Emulsified Slurry 8, and the solvent was removed from Emulsified Slurry 8 over the period of 8 hours at 30° C., followed by aging for 10 hours at 45° C., to thereby obtain Dispersion Slurry 10.

### <Emulsification and Removal of Solvent 11>

A contained was charged with 664 parts of Pigment-Wax Dispersion Liquid 8, 109.4 parts of Non-Crystalline Polyester Solution 3, 73.9 parts of Crystalline Polyester Dispersion Liquid 1, and 4.6 parts of Ketimine Compound 1, and the resulting mixture was mixed for 1 minute at 5,000 rpm by means of TK Homomixer (product of Tokushu Kika Kogyo Co., Ltd.). Thereafter, 1,200 parts of Aqueous Phase 1 was added into the container, and the resulting mixture was mixed for 20 minutes at 13,000 rpm by a TK Homomixer, to thereby obtain Emulsified Slurry 9.

A container equipped with a stirrer and a thermometer was charged with Emulsified Slurry 9, and the solvent was removed from Emulsified Slurry 9 over the period of 8 hours at 30° C., followed by aging for 10 hours at 45° C., to thereby obtain Dispersion Slurry 11.

### <Emulsification and Removal of Solvent 12>

A contained was charged with 664 parts of Pigment-Wax Dispersion Liquid 1, 109.4 parts of Prepolymer 1, 73.9 parts of Crystalline Polyester Dispersion Liquid 1, and 4.6 parts of Ketimine Compound 1, and the resulting mixture was mixed for 1 minute at 5,000 rpm by means of TK Homomixer (product of Tokushu Kika Kogyo Co., Ltd.). Thereafter, 1,200 parts of Aqueous Phase 1 was added into the container, and the resulting mixture was mixed for 20 minutes at 13,000 rpm by a TK Homomixer, to thereby obtain Emulsified Slurry 1.

A container equipped with a stirrer and a thermometer was charged with Emulsified Slurry 1, and the solvent was removed from Emulsified Slurry 1 over the period of 8 hours at 30° C., followed by aging for 30 hours at 45° C., to thereby obtain Dispersion Slurry 12.

### <Emulsification and Removal of Solvent 13>

A contained was charged with 664 parts of Pigment-Wax Dispersion Liquid 1, 109.4 parts of Prepolymer 1, 73.9 parts of Crystalline Polyester Dispersion Liquid 2, and 4.6 parts of Ketimine Compound 1, and the resulting mixture was mixed for 1 minute at 5,000 rpm by means of TK Homomixer (product of Tokushu Kika Kogyo Co., Ltd.). Thereafter, 1,200 parts of Aqueous Phase 1 was added into the container, and the resulting mixture was mixed for 20 minutes at 13,000 rpm by a TK Homomixer, to thereby obtain Emulsified Slurry 10.

A container equipped with a stirrer and a thermometer was charged with Emulsified Slurry 10, and the solvent was removed from Emulsified Slurry 10 over the period of 8 hours at 30° C., followed by aging for 2 hours at 45° C., to thereby obtain Dispersion Slurry 13.

### <Emulsification and Removal of Solvent 14>

A contained was charged with 664 parts of Pigment-Wax Dispersion Liquid 5, 109.4 parts of Prepolymer 1, 73.9 parts of Crystalline Polyester Dispersion Liquid 1, and 4.6 parts of Ketimine Compound 1, and the resulting mixture was mixed for 1 minute at 5,000 rpm by means of TK Homomixer (product of Tokushu Kika Kogyo Co., Ltd.). Thereafter, 1,200 parts of Aqueous Phase 1 was added into the container, and the resulting mixture was mixed for 20 minutes at 13,000 rpm by a TK Homomixer, to thereby obtain Emulsified Slurry 9.

A container equipped with a stirrer and a thermometer was charged with Emulsified Slurry 9, and the solvent was removed from Emulsified Slurry 9 over the period of 8 hours at 30° C., followed by aging for 30 hours at 45° C., to thereby obtain Dispersion Slurry 14.

### <Emulsification and Removal of Solvent 15>

A contained was charged with 664 parts of Pigment-Wax Dispersion Liquid 5, 109.4 parts of Prepolymer 1, 73.9 parts of Crystalline Polyester Dispersion Liquid 2, and 4.6 parts of Ketimine Compound 1, and the resulting mixture was mixed for 1 minute at 5,000 rpm by means of TK Homomixer (product of Tokushu Kika Kogyo Co., Ltd.). Thereafter, 1,200 parts of Aqueous Phase 1 was added into the container, and the resulting mixture was mixed for 20 minutes at 13,000 rpm by a TK Homomixer, to thereby obtain Emulsified Slurry 11.

A container equipped with a stirrer and a thermometer was charged with Emulsified Slurry 11, and the solvent was removed from Emulsified Slurry 11 over the period of 8 hours at 30° C., followed by aging for 2 hours at 45° C., to thereby obtain Dispersion Slurry 15.

### <Emulsification and Removal of Solvent 16>

A contained was charged with 664 parts of Pigment-Wax Dispersion Liquid 9, 109.4 parts of Prepolymer 1, 73.9 parts of Crystalline Polyester Dispersion Liquid 1, and 4.6 parts of Ketimine Compound 1, and the resulting mixture was mixed for 1 minute at 5,000 rpm by means of TK Homomixer (product of Tokushu Kika Kogyo Co., Ltd.). Thereafter, 1,200 parts of Aqueous Phase 1 was added into the container, and the resulting mixture was mixed for 20 minutes at 13,000 rpm by a TK Homomixer, to thereby obtain Emulsified Slurry 12.

A container equipped with a stirrer and a thermometer was charged with Emulsified Slurry 12, and the solvent was removed from Emulsified Slurry 12 over the period of 8 hours at 30° C., followed by aging for 30 hours at 45° C., to thereby obtain Dispersion Slurry 16.

### <Emulsification and Removal of Solvent 17>

A contained was charged with 664 parts of Pigment-Wax Dispersion Liquid 9, 109.4 parts of Prepolymer 1, 73.9 parts of Crystalline Polyester Dispersion Liquid 2, and 4.6 parts of Ketimine Compound 1, and the resulting mixture was mixed for 1 minute at 5,000 rpm by means of TK Homomixer (product of Tokushu Kika Kogyo Co., Ltd.). Thereafter, 1,200 parts of Aqueous Phase 1 was added into the container, and the resulting mixture was mixed for 20 minutes at 13,000 rpm by a TK Homomixer, to thereby obtain Emulsified Slurry 13.

A container equipped with a stirrer and a thermometer was charged with Emulsified Slurry 13, and the solvent was removed from Emulsified Slurry 13 over the period of 8 hours at 30° C., followed by aging for 2 hours at 45° C., to thereby obtain Dispersion Slurry 17.

### <Emulsification and Removal of Solvent 18>

A contained was charged with 664 parts of Pigment-Wax Dispersion Liquid 10, 109.4 parts of Prepolymer 1, 73.9 parts of Crystalline Polyester Dispersion Liquid 1, and 4.6 parts of Ketimine Compound 1, and the resulting mixture was mixed for 1 minute at 5,000 rpm by means of TK Homomixer (product of Tokushu Kika Kogyo Co., Ltd.). Thereafter, 1,200 parts of Aqueous Phase 1 was added into the container, and the resulting mixture was mixed for 20 minutes at 13,000 rpm by a TK Homomixer, to thereby obtain Emulsified Slurry 14.

A container equipped with a stirrer and a thermometer was charged with Emulsified Slurry 14, and the solvent was removed from Emulsified Slurry 14 over the period of 8 hours at 30° C., followed by aging for 30 hours at 45° C., to thereby obtain Dispersion Slurry 18.

### <Emulsification and Removal of Solvent 19>

A contained was charged with 664 parts of Pigment-Wax Dispersion Liquid 10, 109.4 parts of Prepolymer 1, 73.9 parts of Crystalline Polyester Dispersion Liquid 2, and 4.6 parts of Ketimine Compound 1, and the resulting mixture was mixed for 1 minute at 5,000 rpm by means of TK Homomixer (product of Tokushu Kika Kogyo Co., Ltd.). Thereafter, 1,200 parts of Aqueous Phase 1 was added into the container, and the resulting mixture was mixed for 20 minutes at 13,000 rpm by a TK Homomixer, to thereby obtain Emulsified Slurry 15.

A container equipped with a stirrer and a thermometer was charged with Emulsified Slurry 15, and the solvent was removed from Emulsified Slurry 15 over the period of 8 hours at 30° C., followed by aging for 2 hours at 45° C., to thereby obtain Dispersion Slurry 19.

### <Emulsification and Removal of Solvent 20>

A contained was charged with 664 parts of Pigment-Wax Dispersion Liquid 9, 109.4 parts of Prepolymer 1, 73.9 parts of Crystalline Polyester Dispersion Liquid 1, and 4.6 parts of Ketimine Compound 1, and the resulting mixture was mixed for 1 minute at 5,000 rpm by means of TK Homomixer (product of Tokushu Kika Kogyo Co., Ltd.). Thereafter, 1,200 parts of Aqueous Phase 1 was added into the container, and the resulting mixture was mixed for 20 minutes at 13,000 rpm by a TK Homomixer, to thereby obtain Emulsified Slurry 12.

A container equipped with a stirrer and a thermometer was charged with Emulsified Slurry 12, and the solvent was removed from Emulsified Slurry 12 over the period of 8 hours at 30° C., followed by aging for 10 hours at 45° C., to thereby obtain Dispersion Slurry 20.

### <Emulsification and Removal of Solvent 21>

A contained was charged with 664 parts of Pigment-Wax Dispersion Liquid 10, 109.4 parts of Prepolymer 1, 73.9 parts of Crystalline Polyester Dispersion Liquid 1, and 4.6 parts of Ketimine Compound 1, and the resulting mixture was mixed for 1 minute at 5,000 rpm by means of TK Homomixer (product of Tokushu Kika Kogyo Co., Ltd.). Thereafter, 1,200 parts of Aqueous Phase 1 was added into the container, and the resulting mixture was mixed for 20 minutes at 13,000 rpm by a TK Homomixer, to thereby obtain Emulsified Slurry 14.

A container equipped with a stirrer and a thermometer was charged with Emulsified Slurry 14, and the solvent was removed from Emulsified Slurry 14 over the period of 8 hours at 30° C., followed by aging for 10 hours at 45° C., to thereby obtain Dispersion Slurry 21.

### Example 1

### Washing and Drying

After subjecting 100 parts of Dispersion Slurry 1 to filtration under the reduced pressure, the resultant was subjected twice to a series of treatments (1) to (4) described below, to thereby produce Filtration Cake 1:

(1): ion-exchanged water (100 parts) was added to the filtration cake, followed by mixing with TK Homomixer (at 12,000 rpm for 10 minutes) and then filtration;

(2): 10% aqueous sodium hydroxide solution (100 parts) was added to the filtration cake obtained in (1), followed by mixing with TK Homomixer (at 12,000 rpm for 30 minutes) and then filtration under reduced pressure;

(3): 10% by mass hydrochloric acid (100 parts) was added to the filtration cake obtained in (2), followed by mixing with TK Homomixer (at 12,000 rpm for 10 minutes) and then filtration; and

(4): ion-exchanged water (300 parts) was added to the filtration cake obtained in (3), followed by mixing with TK Homomixer (at 12,000 rpm for 10 minutes) and then filtration.

Filtration Cake 1 was dried with an air-circulating drier at 45° C. for 48 hours, and then was caused to pass through a sieve with a mesh size of 75 μm, to thereby prepare Toner 1.

### Example 2

Toner 2 of Example 2 was obtained in the same manner as in Example 1, provided that Dispersion Slurry 1 was replaced with Dispersion Slurry 2.

### Example 3

Toner 3 of Example 3 was obtained in the same manner as in Example 1, provided that Dispersion Slurry 1 was replaced with Dispersion Slurry 3.

### Example 4

Toner 4 of Example 4 was obtained in the same manner as in Example 1, provided that Dispersion Slurry 1 was replaced with Dispersion Slurry 4.

### Example 5

Toner 5 of Example 5 was obtained in the same manner as in Example 1, provided that Dispersion Slurry 1 was replaced with Dispersion Slurry 5.

### Example 6

Toner 6 of Example 6 was obtained in the same manner as in Example 1, provided that Dispersion Slurry 1 was replaced with Dispersion Slurry 6.

### Example 7

Toner 7 of Example 7 was obtained in the same manner as in Example 1, provided that Dispersion Slurry 1 was replaced with Dispersion Slurry 7.

### Example 8

Toner 8 of Example 8 was obtained in the same manner as in Example 1, provided that Dispersion Slurry 1 was replaced with Dispersion Slurry 8.

### Example 9

Toner 9 of Example 9 was obtained in the same manner as in Example 1, provided that Dispersion Slurry 1 was replaced with Dispersion Slurry 9.

### Example 10

Toner 10 of Example 10 was obtained in the same manner as in Example 1, provided that Dispersion Slurry 1 was replaced with Dispersion Slurry 10.

### Example 11

Toner 11 of Example 11 was obtained in the same manner as in Example 1, provided that Dispersion Slurry 1 was replaced with Dispersion Slurry 11.

### Comparative Example 1

Toner 12 of Comparative Example 1 was obtained in the same manner as in Example 1, provided that Dispersion Slurry 1 was replaced with Dispersion Slurry 12.

### Comparative Example 2

Toner 13 of Comparative Example 2 was obtained in the same manner as in Example 1, provided that Dispersion Slurry 1 was replaced with Dispersion Slurry 13.

### Comparative Example 3

Toner 14 of Comparative Example 3 was obtained in the same manner as in Example 1, provided that Dispersion Slurry 1 was replaced with Dispersion Slurry 14.

### Comparative Example 4

Toner 15 of Comparative Example 4 was obtained in the same manner as in Example 1, provided that Dispersion Slurry 1 was replaced with Dispersion Slurry 15.

### Comparative Example 5

Toner 16 of Comparative Example 5 was obtained in the same manner as in Example 1, provided that Dispersion Slurry 1 was replaced with Dispersion Slurry 16.

### Comparative Example 6

Toner 17 of Comparative Example 6 was obtained in the same manner as in Example 1, provided that Dispersion Slurry 1 was replaced with Dispersion Slurry 17.

### Comparative Example 7

Toner 18 of Comparative Example 7 was obtained in the same manner as in Example 1, provided that Dispersion Slurry 1 was replaced with Dispersion Slurry 18.

### Comparative Example 8

Toner 19 of Comparative Example 8 was obtained in the same manner as in Example 1, provided that Dispersion Slurry 1 was replaced with Dispersion Slurry 19.

### Comparative Example 9

Toner 20 of Comparative Example 9 was obtained in the same manner as in Example 1, provided that Dispersion Slurry 1 was replaced with Dispersion Slurry 20.

### Comparative Example 10

Toner 21 of Comparative Example 10 was obtained in the same manner as in Example 1, provided that Dispersion Slurry 1 was replaced with Dispersion Slurry 21.

### <External Additive Treatment>

Each toner (100 parts) obtained in the aforementioned manner was mixed with 0.7 parts of hydrophobic silica, and 0.3 parts of hydrophobic titanium oxide by means of HENSCHEL MIXER. The physical properties of each toner were measured. The results are presented in Table 1.

### <Production of Developer>

The toner (5% by mass) treated with the external additives and a silicone resin-coated Copper-Zinc ferrite carrier (95% by mass) having the average particle diameter of 40 μm were used to prepare a developer.

### <Image Formation>

A continuous printing was performed by means of an image forming apparatus (imagio Neo 450, manufactured by Ricoh Company Limited) capable of printing 45 sheets of A4-size paper per minutes, and evaluations were performed in the following manners.

### <Heat Resistant Storage Stability>

The toner was stored at 50° C. for 8 hours, and then sieved with a 42-mesh sieve for 2 minutes. The amount of the toner remaining on the mesh was measured relative to the total amount of the toner (residual toner rate), and the results were evaluated based on the following criteria. Note that, the better the heat resistant storage stability of the toner, the lower the residual toner rate.

### [Evaluation Criteria]

A: residual toner rate was lower than 10%

B: residual toner rate was 10% or higher, but lower than 30%

C: residual toner rate was 30% or higher

### <Low Temperature Fixing Ability and Hot Offset Resistance>

The fixing portion of the copier (MF 2200, manufactured by Ricoh Company, Ltd.) employing a TEFLON (registered trade mark) roller as a fixing roller was modified to produce a modified copier. The above-produced developer and Type 6200 paper sheets (product of Ricoh Company, Ltd.) were set in the modified copier for printing test.

Specifically, the cold offset temperature (minimum fixing temperature) and the hot offset temperature (maximum fixing temperature) were determined while changing the fixing temperature.

The evaluation conditions for the minimum fixing temperature were set as follows: linear velocity of paper feeding: 120 mm/sec to 150 mm/sec, surface pressure: 1.2 kgf/cm² and nip width: 3 mm.

The evaluation conditions for the maximum fixing temperature were set as follows: linear velocity of paper feeding: 50 mm/sec, surface pressure: 2.0 kgf/cm² and nip width: 4.5 mm.

Note that the minimum fixing temperature of the conventional low temperature fixing toner is about 140° C.

The case where the minimum fixing temperature was lower than 120° C. was evaluated as “A,” the case where the minimum fixing temperature was 120° C. or higher, but lower than 130° C. was evaluated as “B,” the case where the minimum fixing temperature was 130° C. or higher, but lower than 140° C. was evaluated as “C,” and the case where the minimum fixing temperature was 140° C. or higher, but lower than 150° C. was evaluated as “D.”

As for the evaluation of the maximum fixing temperature, the case where the maximum fixing temperature was 190° C. or higher was evaluated as “A,” the case where the maximum fixing temperature was 170° C. or higher, but lower than 190° C. was evaluated as “B,” the case where the maximum fixing temperature was lower than 170° C. was evaluated as “C.”

### <Releasing Properties During Fixing>

A modified device of an image forming apparatus (imagio MP7500, manufactured by Ricoh Company Limited) whose fixing unit had been modified was used to print an image on sheets so that a deposition amount became constant (0.85 mg/cm²) on each sheet, to thereby measure the force required for releasing while varying a fixing temperature.

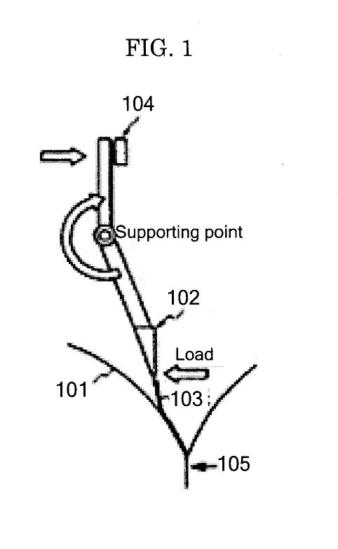

As illustrated in FIG. 1, a separation claw 102 for measurement was provided as a measurement device for measuring the separation force at the side of the fixing roller just after the fixing nip. The releasing force was measured as the force of the sheet 103, which had been passed through the fixing nip 105, to wrap around the fixing roller 101.

Since the sheet 103 passed through the fixing nip was transported with bearing the force for wrapping around the fixing roller, the sheet was transported with pressed against the detection claw 102. The pressing force during this was read by a load cell 104 provided at one edge of the separation claw, and determined as the separation force (gf).

Since the separation force became the maximum value at a certain fixing temperature, the fixing temperature was varied, and the separation force at the fixing temperature where the separation force became the maximum value was determined as separation resistance, and releasing properties were evaluated based on the following criteria.

### [Evaluation Criteria]

A: small separation resistance

B: large separation resistance

C: impossible to separate

The evaluation results of Examples 1 to 11 and Comparative Examples 1 to 10 are presented in Table 1.

TABLE 1

| | | | | | Heat | | Low | | |
|---|---|---|---|---|---|---|---|---|---|
| | | | | | resistant | Fixing | tem. | | |
| | | | | FTIR- | storage | upper | fixing | Separation | Total |
| | Tg 1st | Tg 2nd | T½ | ATR | stability | limit | ability | resistance | judgment |
| Ex. 1 | 65 | 35 | 120 | 0.10 | A | A | B | B | B |
| Ex. 2 | 65 | 35 | 135 | 0.11 | A | B | B | B | B |
| Ex. 3 | 45 | 25 | 120 | 0.12 | B | A | A | B | B |
| Ex. 4 | 45 | 25 | 135 | 0.13 | B | A | A | B | B |
| Ex. 5 | 65 | 35 | 120 | 0.11 | A | B | B | B | B |
| Ex. 6 | 65 | 39 | 125 | 0.13 | A | A | A | A | A |
| Ex. 7 | 57 | 38 | 124 | 0.16 | A | A | A | A | A |
| Ex. 8 | 56 | 39 | 123 | 0.20 | B | A | A | B | B |
| Ex. 9 | 64 | 35 | 121 | 0.11 | A | B | A | B | B |
| Ex. 10 | 66 | 36 | 125 | 0.13 | A | B | A | A | A |
| Ex. 11 | 65 | 34 | 134 | 0.19 | B | B | B | A | B |
| Comp. | 66 | 36 | 136 | 0.10 | B | A | D | B | C |
| Ex. 1 | | | | | | | | | |
| Comp. | 44 | 24 | 119 | 0.10 | C | C | A | C | C |
| Ex. 2 | | | | | | | | | |
| Comp. | 66 | 36 | 136 | 0.20 | B | A | D | A | C |
| Ex. 3 | | | | | | | | | |
| Comp. | 44 | 24 | 119 | 0.20 | C | C | A | C | C |
| Ex. 4 | | | | | | | | | |
| Comp. | 66 | 36 | 136 | 0.08 | A | A | D | C | C |
| Ex. 5 | | | | | | | | | |
| Comp. | 44 | 24 | 119 | 0.08 | C | C | A | C | C |
| Ex. 6 | | | | | | | | | |
| Comp. | 66 | 36 | 136 | 0.21 | C | A | D | B | C |
| Ex. 7 | | | | | | | | | |
| Comp. | 44 | 24 | 119 | 0.23 | C | C | A | C | C |
| Ex. 8 | | | | | | | | | |
| Comp. | 57 | 38 | 123 | 0.09 | A | C | A | C | C |
| Ex. 9 | | | | | | | | | |
| Comp. | 56 | 39 | 124 | 0.22 | C | A | A | A | C |
| Ex. 10 | | | | | | | | | |

It was found from the results presented in Table 1 that in Examples 1 to 11, the toners having excellent heat resistant storage stability, maximum fixing temperature, low temperature fixing ability, and separation resistance were obtained. On the other hand, the toners of Comparative Examples 1 to 10 had inferior results in heat resistant storage stability, maximum fixing temperature, low temperature fixing ability, and separation resistance.

Comparing Example 1 with Example 2, and Example 3 with Example 4, it was found that the difference in the aging duration after the removal of the solvent became the factor for changing the ½ flow onset temperature T½ of the toner.

Comparing Examples 1 and 2 with Examples 3 and 4, it was found that the changes in the amount of Prepolymer 1 and the amount of Ketimine Compound 1 became factors for changing the glass transition temperature Tg1st of the toner for the first heating in DSC, and the glass transition temperature Tg2nd of the toner for the second heating in DSC.

Comparing Example 1 with Example 5, it was found that the difference in the conditions for preparing the pigment-wax dispersion liquid became a factor for varying separation resistance.

Comparing Example 6, Example 7, and Example 8, it was found that the difference in the amount (parts) of the wax dispersant became a factor for changing the peak intensity of the toner in FTIR-ATR.

Comparing Example 1 with Example 9, it was found that the existence of the prepolymer became a factor for varying the maximum fixing temperature.

Comparing Example 9, Example 10, and Example 11, it was found that the difference in the solid content of Non-Crystalline Polyester 2 caused the difference in the peak intensity of the toner in FTIR-ATR, which contributed to heat resistant storage stability, low temperature fixing ability, and reparation resistance of the toner.

As described above, in the present embodiment, a toner for developing an electrostatic image is obtained by dispersing an oil phase in an aqueous medium in which a particulate dispersant is present to obtain an emulsified dispersion liquid, where the oil phase is prepared by dissolving or dispersing, in an organic solvent, at least a binder resin containing a crystalline polyester resin and a non-crystalline resin, a colorant, and a releasing agent; and removing the organic solvent. The toner has glass transition temperature Tg1st of 45° C. to 65° C., and glass transition temperature Tg2nd of 25° C. to 35° C., where the Tg1st is glass transition temperature of the toner for the first heating in DSC and the Tg2nd is glass transition temperature of the toner for the second heating in DSC; the toner has ½ flow onset temperature T½ of 120° C. to 135° C.; and the toner has a peak intensity ratio of 0.10 to 0.20, where the peak intensity ratio is a ratio of an intensity of a peak derived from the crystalline polyester resin and the releasing agent to an intensity of a peak derived from the binder resin as measured in FTIR-ATR. Accordingly, the toner having excellent low temperature fixing ability, heat resistant storage stability, and separation ability can be attained.

According to the present embodiment, the binder resin contains a binder resin precursor that is a modified polyester resin serving as the non-crystalline resin, and a compound capable of elongating or crosslinking with the binder resin precursor is dissolved in the oil phase, and the binder resin precursor is allowed to proceed to a crosslink reaction and/or elongation reaction in the emulsified dispersion liquid. As a result, the crystalline polyester can be introduced into the non-crystalline resin.

According to the present embodiment, a toner satisfying the aforementioned properties can be attained by forming the crystalline polyester with C4-C12 saturated dicarboxylic acid and C4-C12 saturated diol.

According to the present invention, the crystalline polyester has a proportion of molecules having the number molecular weight Mn of 500 or smaller being 0% to 2.0% and a proportion of molecules having Mn of 1,000 or smaller being 0% to 4.0%, as measured in GPC. Regarding the molecular weight of the crystalline polyester, the crystalline polyester with a sharp molecular weight distribution and low molecular weight has excellent low temperature fixing ability, and the crystalline polyester with the large proportion of low molecular weight molecules thereof has insufficient heat resistant storage stability. Therefore, the crystalline polyester having the molecular weight distribution within the aforementioned ranges can achieve both low temperature fixing ability and heat resistant storage stability.

According to the present embodiment, the oil phase contains a dispersant for improving the dispersibility of the crystalline polyester resin and the releasing agent (wax). As a result, desirable dispersibility of the crystalline polyester resin and that of the wax to the binder resin can be attained, and the amounts of the crystalline polyester and that of wax in an area adjacent to a surface of a toner particle can be controlled. Accordingly, the toner satisfying the aforementioned properties can be attained.

According to the present embodiment, a developer having excellent low temperature fixing ability, heat resistant storage stability, and separation ability can be provided by containing the aforementioned toner in the developer.

The embodiments of the present invention are as follows:

<1> A toner, containing:

a binder resin containing a crystalline resin and a non-crystalline resin;

a colorant; and

a releasing agent,

wherein the toner has ½ flow onset temperature T½ of 120° C. to 135° C., and

wherein a peak intensity ratio of an intensity of a peak derived from the crystalline resin and the releasing agent to an intensity of a peak derived from the binder resin as measured in FTIR-ATR is 0.10 to 0.20.

<2> The toner according to <1>, wherein the toner has glass transition temperature Tg1st of 45° C. to 65° C., and glass transition temperature Tg2nd of 25° C. to 35° C., where the glass transition temperature Tg1st is glass transition temperature of the toner determined from first heating in DSC, and the glass transition temperature Tg2nd is glass transition temperature of the toner determined from second heating in DSC.
<3> The toner according to any of <1> or <2>, wherein the crystalline resin is a crystalline polyester resin, and

wherein the toner is obtained by the method containing:

dispersing an oil phase in an aqueous medium including a particulate dispersant to form an emulsified dispersion liquid, where the oil phase is prepared by dissolving or dispersing the binder resin containing the crystalline polyester resin and the non-crystalline resin, the colorant, and the releasing agent in an organic solvent; and

removing the organic solvent from the emulsified dispersion liquid.

<4> The toner according to <3>, wherein the non-crystalline resin is a binder resin precursor which is formed of a modified polyester resin, and

wherein the method further contains dissolving a compound capable of elongating or crosslinking with the binder resin precursor in the oil phase, and allowing the binder resin precursor to undergo a crosslink reaction, or an elongation reaction, or the both in the emulsified dispersion liquid.

<5> The toner according to any one of <1> to <4>, wherein the crystalline resin is a crystalline polyester resin that is synthesized from a C4-C12 saturated dicarboxylic acid and a C4-C12 saturated diol.
<6> The toner according to any one of <1> to <5>, wherein the crystalline resin has a proportion of molecules thereof having a number molecular weight of 500 or smaller being 0% to 2.0%, and a proportion of molecules thereof having a number molecular weight of 1,000 or smaller being 0% to 4.0%, where the number molecular weights are measured in GPC.
<7> The toner according to any one of <3> to <6>, wherein the oil phase further contains a dispersant capable of improving dispersibilities of the crystalline polyester resin and the releasing agent.
<8> A developer containing:

the toner as defined in any one of <1> to <7>.

This application claims priority to Japanese application No. 2011-111168, filed on May 18, 2011, and incorporated herein by reference.

What is claimed is:

1. A toner, comprising:
a binder resin containing a crystalline resin and a non-crystalline resin;
a colorant; and
a releasing agent,
wherein the toner has ½ flow onset temperature T½ of 120° C. to 135° C., and
wherein a peak intensity ratio of an intensity of a peak derived from the crystalline resin and the releasing agent to an intensity of a peak derived from the binder resin as measured in FTIR-ATR is 0.10 to 0.20.

2. The toner according to claim 1, wherein the toner has glass transition temperature Tg1st of 45° C. to 65° C., and glass transition temperature Tg2nd of 25° C. to 35° C., where the glass transition temperature Tg1st is glass transition temperature of the toner determined from first heating in DSC, and the glass transition temperature Tg2nd is glass transition temperature of the toner determined from second heating in DSC.

3. The toner according to claim 1, wherein the crystalline resin is a crystalline polyester resin, and
wherein the toner is obtained by the method containing:
dispersing an oil phase in an aqueous medium including a particulate dispersant to form an emulsified dispersion liquid, where the oil phase is prepared by dissolving or dispersing the binder resin containing the crystalline polyester resin and the non-crystalline resin, the colorant, and the releasing agent in an organic solvent; and
removing the organic solvent from the emulsified dispersion liquid.

4. The toner according to claim 3, wherein the non-crystalline resin is a binder resin precursor which is formed of a modified polyester resin, and
wherein the method further contains dissolving a compound capable of elongating or crosslinking with the binder resin precursor in the oil phase, and allowing the binder resin precursor to undergo a crosslink reaction, or an elongation reaction, or the both in the emulsified dispersion liquid.

5. The toner according to claim 1, wherein the crystalline resin is a crystalline polyester resin that is synthesized from a C4-C12 saturated dicarboxylic acid and a C4-C12 saturated diol.

6. The toner according to claim 1, wherein the crystalline resin has a proportion of molecules thereof having a number molecular weight of 500 or smaller being 0% to 2.0%, and a proportion of molecules thereof having a number molecular weight of 1,000 or smaller being 0% to 4.0%, where the number molecular weights are measured in GPC.

7. The toner according to claim 3, wherein the oil phase further contains a dispersant capable of improving dispersibilities of the crystalline polyester resin and the releasing agent.

8. A developer comprising:
a toner, which contains:
a binder resin containing a crystalline resin and a non-crystalline resin;
a colorant; and
a releasing agent,
wherein the toner has ½ flow onset temperature T½ of 120° C. to 135° C., and
wherein a peak intensity ratio of an intensity of a peak derived from the crystalline resin and the releasing agent to an intensity of a peak derived from the binder resin as measured in FTIR-ATR is 0.10 to 0.20.
